(19) United States
(12) Patent Application Publication
(10) Pub. No.: US 2007/0072153 A1
(43) Pub. Date: Mar. 29, 2007

(54) Photo-sterilization

(76) Inventors: Yossi Gross, Moshav Mozor (IL); Daniel Better, Rehovot (IL); Baruch Levy, Ramat Gan (IL); Dvir Keren, Tel Aviv (IL)

Correspondence Address: Martin D Moynihan;PRTSI Inc., P O Box 16446, Arlington, VA, 22215, US

(21) Appl. No.: 10/564,165

(22) PCT Filed: Jul. 11, 2004
(86) PCT No.: PCT/IL04/00620

§ 371 Date: Sep. 1, 2006

Related U.S. Application Data
(60) Provisional application No. 60/485,402, filed on Jul. 9, 2003.
(60) Provisional application No. 60/556,882, filed on Mar. 29, 2004.

(51) Int. Cl. A61C 5/02

(52) U.S. Cl. 433/224

(57) ABSTRACT

The present invention provides substances, devices, methods, and kits for photo-sterilization of a root canal, prior to and when performing endodontics, as well as periodically as post-endodontic prophylactic measures. The root-canal filling includes a light-transmitting element, operative as a diffuser, and methods are provided for communicating light to the diffuser, for disinfecting the walls of the root canals, by photo sterilization. The diffuser may be formed of silicone polymers, synthetic fused silica, quartz or the like, and may be surrounded by a light-transmitting sealer. The diffuser may be incorporated with an endodontic post, or a specially designed post, which may be transparent and (or) hollow. In a preferred embodiment, the diffuser is formed of a light transmitting conical shell of Cyclic Olefin Copolymers (COC), filled with a fluid such as air, distilled water, or silicone oil.

### FIELD AND BACKGROUND OF THE INVENTION

The present invention relates to endodontics, or root canal therapy, and, more particularly, to substances, devices, methods, and kits for photo-sterilization of a root canal, prior to and when performing endodontics, as well as periodically as post-endodontic prophylactic measures, and in cases of endodontic treatment failures. Additionally, the present invention relates to intracorporeal photo-sterilization of the internal walls of a catheter. FIG. 1 is a cross-sectional view of a tooth 10, as taught, for example, by http://www.dentalreview.com/tooth_anatomy.htm As seen in the figure, the basic parts of a tooth are: a crown 12, the portion of tooth above a gum 14, and a root or roots 16, which anchor the tooth in a jawbone 15. A pulp 18 is arranged within a pulp chamber 20 and within a root canal or root canals 22.

Crown 12 is formed of an inner structure of dentine 26 and an external layer of enamel 24, which defines a chewing surface 28. There may be one, two, or four roots 16. Each has an external layer of cement 30, inner structure of dentine 26, and at least one root canal 22. Pulp 18 is formed of tiny blood vessels, which carry nutrients to the tooth, and nerves, which give feeling to the tooth. These enter root canals 22 via accessory canals 32 and root-end openings 34.

Tooth 10 may define a cylindrical coordinate system of a longitudinal axis x, and a radius r. A proximal end 36 may be defined as the end above gum 14 and a distal end 38 may be defined as the end below it

When the pulp is diseased or injured and can't repair itself it dies. Common causes of pulp death are a deep cavity, a cracked filling, or a cracked tooth. Bacteria then invade the tooth and infect the pulp. The inflammation and infection may spread down the root canal, often causing sensitivity to hot or cold foods and pain.

Treatment involves removing the diseased pulp and cleaning and sealing the pulp chamber and root canals, then filling or restoring the crown. The steps in root canal therapy are described, for example, in http://your-doctor.com/patient_info/dental_info/dental_disorders/rootcanal.html#1. “Root Canal (Endodontic) Therapy,” and are illustrated in FIGS. 2A-2M below.

FIGS. 2A-2C illustrate situations in which crown 12 was not severely damaged. As seen in FIG. 2A, an opening 40 is made, generally through crown 12 and dentine 26, into pulp chamber 20. Pulp 18 (FIG. 1) is then removed with a tiny file (not shown), and pulp chamber 20 and root canals 22 are cleaned and shaped to a form that can be filled.

As seen in FIG. 2B, medication 42 may be applied to pulp chamber 20, and root canals 22, for a period of about two weeks, to disinfect them. Medications 42 may be, for example, calcium hydroxide, or another antiseptic medication as known. A temporary filling 44 may be placed in crown opening 40 to protect the tooth between dental visits. Temporary filling 44 may be IRM, GC Fuji 9, or Acrofill, or another temporary filling as known, in order to prevent re-infection of root canals 22, until the next dental visit, and possibly in order to restore the chewing surface.

As seen in FIG. 2C, after removing medications 42 and temporary filling 44 of FIGS. 2B, pulp chamber 20 and root canals 2Z are cleaned and filled with a permanent filling 46, such as a conventional composite, and chewing surface 28 is restored.

FIGS. 2D-2G illustrate situations in which crown 12 (FIG. 1) was severely damaged, or needs to be reconstructed for aesthetical or other reasons. As seen in FIG. 2D, remnants of crown 12 are removed, and root canals 22 are cleaned and shaped as above.

As seen in FIG. 2E, medications 42, such as calcium hydroxide, may be applied to root canals 22, for a period of about two weeks, to disinfect them. A sealing layer 27, such as IM, GC Fuji 9, ACROFILL, or the like, may then be applied over the exposed dentine, to protect it until the next dental visit.

As seen in FIG. 2F, after removing medications 42 of FIG. 2E, root canals 22 are cleaned and filled with permanent filling 46, such as a conventional composite. A core 29 is then constructed of permanent filling 46, to restore crown 12, and a mold (not shown) is taken of the core. A temporary structure 50 is then placed over core 29.

As seen in FIG. 2G, a permanent, enamel-like structure 52 is prepared from the mold, and placed over core 29.

FIGS. 2H-2J illustrate another mode of treatment, alternative to that of FIG. 2C.

After cleaning and reshaping root canals 22, as seen in FIG. 2A, and applying medication, as seen in FIG. 2B, root canals 22 are filled with a root filling material 45, for example, Gutta Percha 45, or paste 45, to an apical point 20A of pulp chamber 20. Pulp chamber 20 is then filled with temporary filling 44 or sealing layer 44.

As seen in FIG. 2I, upon the next dental visit, temporary filling 44 as well as some of root canal filling 45 are removed, and a post 21, also known as a dowel 21 is inserted from pulp chamber 20 to root canal 22, and cemented in place using a dental cement 47 or a sealer 47, for example, composite cement, zinc-phosphate cement, or another cement or sealer as known.

As seen in FIG. 2J, opening 40 of crown 12 is restored using conventional composite 46 or amalgam 46, or the like.

FIGS. 2K-2M illustrate another mode of treatment, alternative to that of FIGS. 2F-2G, in which crown 12 is to be reconstructed.

As seen in FIG. 2K, root canals 22 are filled with root canal filling 45, such as Gutta Percha 45, to apical point 20A of pulp chamber 20.

As seen in FIG. 2L, post 21 may be applied partially through root canal 22, and cemented in place. Core 29 may then be constructed, for example, of conventional composite 46 or Amalgam 46.

Post 21 (FIGS. 2I, 2J, 2L) may be formed of a metal, such as a dental alloy, as known, or from quartz, reinforced carbon fibers, or another suitable material. Post 21 may be rigid or flexible, to some extent. Where two or more root canals are being treated, one or more posts may be used.

Post 21 may be prefabricated and where needed, shaped in the dental clinic. Alternatively, a mold of the root canals and remaining tooth may be taken in the dental clinic and sent to a dental laboratory, and post is tailor-made based on the mold.

Alternatively, as seen in FIG. 2K, post 21 and core 29 may be prepared in a dental laboratory, as a single unit 49, based on a mold taken in the dental clinic. Single unit 49 may be formed of a metal, such as a dental alloy, or another suitable material.

Generally, the treatment involves an endodontist, which removes the diseased pulp and cleans and seals the pulp chamber and root canals, a prosthodontist, who fills or restores the crown, and a dental technician, who prepares the restored crown, based on a mold prepared by the prosthodontist.

However, in spite of careful and thorough disinfection, it may be incomplete, and latent infections may linger in the filled roots. In fact, disinfection of the root canal still remains a primary goal in endodontics. There is thus a widely recognized need for, and it would be highly advantageous to have, substances, devices, and methods for thorough sterilization of the root canal.

### SUMMARY OF THE INVENTION

According to one aspect of the present invention, there is provided a method of root-canal photo-sterilizing, comprising:

forming an opening into the pulp chamber of a tooth;

removing the pulp from at least one infected root canal of the tooth;

cleaning the walls of the at least one root canal; and

photo-sterilizing the walls, by shining on them with light at a combination of wavelength and intensity operative to disinfect the walls.

According to an additional aspect of the present invention, the photo-sterilizing the walls further comprises photo-sterilizing with a diffuser.

According to an additional aspect of the present invention, the diffuser is formed of a light-transmitting shell and a fluid enclosed therein.

According to an additional aspect of the present invention, the light-transmitting shell is flexible.

According to an additional aspect of the present invention, the light-transmitting shell is formed of a polymer.

According to an additional aspect of the present invention, the light-transmitting shell is formed of Cyclic Olefin Copolymers (COC).

According to an additional aspect of the present invention, the light-transmitting shell is formed of COC 8007 Hi UV.

According to an additional aspect of the present invention, the light-transmitting shell is between 0.1 and 0.3 mm thick.

According to an additional aspect of the present invention, the light-transmitting shell is substantially 0.2 mm thick.

According to an additional aspect of the present invention, the fluid is selected from the group consisting of air, water and oil.

According to an additional aspect of the present invention, the shell is adapted to couple with an optical fiber by fitting around the optical fiber and gluing thereto.

According to an alternative aspect of the present invention, the shell is adapted to couple with an optical fiber by tightly fitting around the optical fiber, for a quick connection.

According to an additional aspect of the present invention, the shell is formed of a material which changes color after exposure to UV light, thus indicating that the diffuser has been used and must be disposed.

According to an additional aspect of the present invention, the material is a thermoplastic polyurethane (TPU).

According to an additional or an alternative aspect of the present invention, the shell comprises a diaphragm formed of a material which changes color after exposure to UV light, thus indicating that the diffuser has been used and must be disposed.

According to an additional aspect of the present invention, the material is a thermoplastic polyurethane (TPU).

According to an additional aspect of the present invention, a surface of the optical fiber, which forms contact with the fluid, is machined to form a lens, for improved light diffusion.

According to an additional aspect of the present invention, the wavelength is between 150 and 300 nm.

According to an alternative aspect of the present invention, the wavelength is between 300 and 500 nm.

According to an alternative aspect of the present invention, the wavelength is between 500 and 700 nm.

According to an alternative aspect of the present invention, the wavelength is between 700 and 1000 nm.

According to an alternative aspect of the present invention, the wavelength is between 1000 and 2000 nm.

According to an alternative aspect of the present invention, the wavelength is between 2000 and 12000 nm.

According to an additional aspect of the present invention, the light intensity on the walls of between 3 and 300 mJ/cm2.

According to an additional aspect of the present invention, the light is laser light.

According to an additional aspect of the present invention, the method further comprises filling and restoring the tooth.

According to another aspect of the present invention, there is provided a method of performing post-endodontic photo-sterilization of a root canal, comprising:

forming an opening into the pulp chamber of a tooth;

removing the pulp from at least one infected root canal of the tooth;

cleaning and shaping the walls of the at least one root canal;

filling the at least one root canal with a filling substance which comprises at least one light-transmitting element, in communication with the walls;

restoring the tooth; and

performing post-endodontic photo-sterilization of the root canal, by coupling a light source, at a combination of wavelength and intensity operative to disinfect the walls, with the at least one light-transmitting element.

According to an additional aspect of the present invention, the wavelength is between 150 and 300 nm.

According to an alternative aspect of the present invention, the wavelength is between 300 and 500 nm.

According to an alternative aspect of the present invention, the wavelength is between 500 and 700 nm.

According to an alternative aspect of the present invention, the wavelength is between 700 and 1000 nm.

According to an alternative aspect of the present invention, the wavelength is between 1000 and 2000 nm.

According to an alternative aspect of the present invention, the wavelength is between 2000 and 12000 nm.

According to an additional aspect of the present invention, the light intensity on the walls of between 3 and 300 mJ/cm2.

According to an additional aspect of the present invention, the light is laser light.

According to an additional aspect of the present invention, the at least one light-transmitting element comprises at least one diffuser and a light-transmitting sealer.

According to an additional aspect of the present invention, the at least diffuser is formed of a material selected from the group consisting of silicone polymers, synthetic fused silica, quartz, poly-olefins, none-crystalline polyolefin, and a combination thereof.

According to an additional aspect of the present invention, the at least one diffuser is formed of a light-transmitting shell and a fluid enclosed therein.

According to an additional aspect of the present invention, the light-transmitting shell is flexible.

According to an additional aspect of the present invention, the light-transmitting shell is formed of a polymer.

According to an additional aspect of the present invention, the light-transmitting shell is formed of Cyclic Olefin Copolymers (COC).

According to an additional aspect of the present invention, the light-transmitting shell is formed of COC 8007 Hi WV.

According to an additional aspect of the present invention, the light-transmitting shell is between 0.1 and 0.3 mm thick

According to an additional aspect of the present invention, the light-transmitting shell is substantially 0.2 mm thick.

According to an additional aspect of the present invention, the fluid is selected from the group consisting of air, water and oil.

According to an additional aspect of the present invention, the shell is adapted to couple with an optical fiber by fitting around the optical fiber and gluing thereto.

According to an additional aspect of the present invention, the shell is adapted to couple with an optical fiber by tightly fitting around the optical fiber, for a quick connection.

According to an additional aspect of the present invention, a surface of the optical fiber, which forms contact with the fluid, is machined to form a lens, for improved light diffusion.

According to an additional aspect of the present invention, the diffuser is sealed with a plug, for insertion into a root canal, and further wherein the diffuser may be unplugged by inserting a hyperdemic needle through the plug, and pressurizing the diffuser, thus causing the plug to pop out, for performing the post-endodontic photo-sterilization of the root canal.

According to an additional aspect of the present invention, the at least diffuser is designed with two branches.

According to an additional aspect of the present invention, the at least diffuser is designed with three branches.

According to an additional aspect of the present invention, the at least diffuser is designed with four branches.

According to an additional aspect of the present invention, the diffuser is formed as a plurality of optical fibers of different lengths, held together with a light transmitting sealant.

According to an additional aspect of the present invention, the light-transmitting sealer is formed as a mixture, comprising:

an adhesive, selected from the group consisting of silicone polymers, silica, silicate, and a combination thereof; and

a filler, selected from the group consisting of fumed silica, quartz particles, barium sulfate, ring-opening-polymers, and a combination thereof,

wherein the mixture comprises between 2% and 50% of the filler.

According to still another aspect of the present invention, there is provided a substance, operative as a light-transmitting sealer in a tooth filling, formed as a mixture, comprising:

an adhesive, selected from the group consisting of silicone polymers, silica, silicate, and a combination thereof; and

a filler, selected from the group consisting of fumed silica, quartz particles, barium sulfate, ring-opening polymers, and a combination thereof,

wherein the mixture comprises between 2% and 50% of the filler.

According to yet another aspect of the present invention, there is provided a endodontic diffuser, adapted in size and shape to be inserted into at least one root canal, for transmitting light by diffusion, for photo-sterilization of the root canal.

According to an additional aspect of the present invention, the endodontic diffuser is formed of a material selected from the group consisting of silicone polymers, synthetic fused silica, quartz, poly-olefins, none-crystalline polyolefin, and a combination thereof.

According to an additional aspect of the present invention, the at least diffuser is formed of a light-transmitting shell and a fluid enclosed therein.

According to an additional aspect of the present invention, the light-transmitting shell is flexible.

According to an additional aspect of the present invention, the light-transmitting shell is formed of a polymer.

According to an additional aspect of the present invention, the light-transmitting shell is formed of Cyclic Olefin Copolymers (COC).

According to an additional aspect of the present invention, the light-transmitting shell is formed of COC 8007 Hi UV.

According to an additional aspect of the present invention, the light-transmitting shell is between 0.1 and 0.3 mm thick.

According to an additional aspect of the present invention, the fluid is selected from the group consisting of air, water and oil.

According to an additional aspect of the present invention, the shell is adapted to couple with an optical fiber by fitting around the optical fiber and gluing thereto.

According to an alternative aspect of the present invention, the shell is adapted to couple with an optical fiber by tightly fitting around the optical fiber, for a quick connection.

According to an additional aspect of the present invention, a surface of the optical fiber, which forms contact with the fluid, is machined to form a lens, for improved light diffusion.

According to an additional aspect of the present invention, the diffuser is sealed with a plug, for insertion into a root canal, and further wherein the diffuser may be unplugged by inserting a hyperdemic needle through the plug, and pressurizing the diffuser, thus causing the plug to pop out, for performing the post-endodontic photo-sterilization of the root canal.

According to an additional aspect of the present invention, the endodontic diffuser has a length of between 8 and 25 mm in length.

According to an additional aspect of the present invention, the endodontic diffuser is shaped generally as a cylindrical cone, and having a proximal diameter with respect to a crown of the tooth of between 0.5 and 2.0 mm.

According to an additional aspect of the present invention, the endodontic diffuser has two branches.

According to an additional aspect of the present invention, the endodontic diffuser has three branches.

According to an additional aspect of the present invention, the endodontic diffuser has four branches.

According to an additional aspect of the present invention, the endodontic diffuser is formed as a plurality of optical fibers of different lengths, held together with a light transmitting sealant.

According to an additional aspect of the present invention, the endodontic diffuser comprises a plurality of surface pits whose diameters increase along the length of the diffuser, from between about 0.03 and about 0.05 mm in diameter, at a proximal end, with respect to the crown of the tooth, to between about 0.08 and about 0.15 mm in diameter, at a distal end, for providing a generally even light intensity on the walls.

According to an additional aspect of the present invention, the endodontic diffuser comprises a plurality of surface channels whose widths increase along the length of the diffuser, from between about 0.10 and about 0.15 mm, at a proximal end, with respect to the crown of the tooth, to between about 0.20 and about 0.30 mm, at a distal end, for providing a generally even light intensity on the walls.

According to an additional aspect of the present invention, the endodontic diffuser comprises a light coupler.

According to an additional aspect of the present invention, the endodontic diffuser comprises an optical-grade surface at a proximal end with respect the crown of the tooth.

According to an additional aspect of the present invention, the endodontic diffuser comprises a removable cap, for protecting the optical-grade surface.

According to one still aspect of the present invention, there is provided a ring-shaped diffuser, adapted in size and shape to be inserted at an interface between a restored crown and a dentine tissue of a tooth, for transmitting light by diffusion, for photo-sterilization of the interface.

According to an additional aspect of the present invention, the ring-shaped diffuser is formed of a material selected from the group consisting of silicone polymers, synthetic fused silica, quartz, poly-olefins, none-crystalline polyolefin, and a combination thereof.

According to one yet aspect of the present invention, there is provided a method of performing photo-sterilization of an interface between a restored crown and a dentine tissue, comprising:

placing a light transmitting element at the interface; and

performing photo-sterilization of the interface, by coupling a light source, at a combination of wavelength and intensity operative to disinfect the interface, with the light transmitting element.

According to one still aspect of the present invention, there is provided a metal support for endodontic, which defines a lumen, for inserting a light transmission element therein.

According to one yet aspect of the present invention, there is provided a hollow metal support for endodontic, adapted as a light coupler, for providing light coupling between an optical fiber and a light-transmitting element of a root canal filling substance.

According to one still aspect of the present invention, there is provided a photo-sterilization kit, comprising:

a diffuser, having proximal and distal ends, with respect to a crown of a tooth, and adapted in size and shape for insertion into a root canal of the tooth; and

a light coupler, formed as a metal sleeve, attached to the diffuser at the distal end,

wherein the light coupler is further operative as a support for strengthening the root canal filling.

According to an additional aspect of the present invention, the kit further comprises a distal shield.

According to an additional aspect of the present invention, the kit further comprises separate adhesive and filler tubes.

According to an additional aspect of the present invention, the kit further comprises a premixed adhesive and filler tube.

According to an additional aspect of the present invention, the kit further comprises a plurality of diffusers.

According to an additional aspect of the present invention, the kit further comprises a plurality of diffusers of different shapes and sizes.

According to one still aspect of the present invention, there is provided a method of identifying a perforation in a root canal dentine, comprising:

wounding a spiraling conductive wire around an element, adapted in size and shape to fit into a root canal;

inserting the an element into a root canal;

applying a voltage to the wire; and

measuring a current flow from the conductive wire to a gum tissue, external to the dentine.

According to an additional aspect of the present invention, the element is a diffuser.

According to an additional aspect of the present invention, the method is performed prior to performing endodontics.

According to an additional aspect of the present invention, the element wound with a conductive wire is embedded in a root canal, and the method is performed periodically as a post-endodontic prophylactic measure.

According to another aspect of the present invention, there is provided a method for intracorporeal photo-sterilization of an internal wall of a catheter, comprising:

providing a catheter, which is intracorporeally inserted;

inserting into the catheter, an optical fiber, having proximal and distal ends with respect to an operator; and

shining a light through the optical fiber, while the inserting proceeds, the light being at a combination of wavelength and intensity operative to disinfect the internal wall of the catheter.

According to an additional aspect of the present invention, the catheter is opaque to the light.

According to an additional aspect of the present invention, the light is ultraviolet light.

According to an additional aspect of the present invention, the wavelength is between 150 and 300 nm.

According to an alternative aspect of the present invention, the wavelength is between 300 and 500 nm.

According to an alternative aspect of the present invention, the wavelength is between 500 and 700 nm.

According to an alternative aspect of the present invention, the wavelength is between 700 and 1000 mm.

According to an alternative aspect of the present invention, the wavelength is between 1000 and 2000 nm.

According to an alternative aspect of the present invention, the wavelength is between 2000 and 12000 nm.

According to an additional aspect of the present invention, the light intensity on the walls of between 3 and 300 mJ/cm2.

According to an additional aspect of the present invention, the light is laser light.

According to an additional aspect of the present invention, the photo-sterilizing comprises photo-sterilizing with a diffuser, the diffuser being coupled to the distal end of the optical fiber.

According to an additional aspect of the present invention, the diffuser is formed of a silicate compound.

According to an alternative aspect of the present invention, the diffuser is formed of a silicone polymer.

According to an alternative aspect of the present invention, the diffuser is formed of a light-transmitting shell and a fluid enclosed therein.

According to an additional aspect of the present invention, the light-transmitting shell is flexible.

According to an additional aspect of the present invention, the light-transmitting shell is formed of a polymer.

According to an additional aspect of the present invention, the light-transmitting shell is formed of Cyclic Olefin Copolymers (COC).

According to an additional aspect of the present invention, the light-transmitting shell is formed of COC 8007 Hi UV.

According to an additional aspect of the present invention, the light-transmitting shell is between 0.1 and 0.3 mm thick.

According to an additional aspect of the present invention, the light-transmitting shell is substantially 0.106 mm thick.

According to an additional aspect of the present invention, the fluid is selected from the group consisting of air, water and oil.

According to an additional aspect of the present invention, the light-transmitting shell is adapted to couple with an optical fiber by fitting around the optical fiber and gluing thereto.

According to an alternative aspect of the present invention, the light-transmitting shell is adapted to couple with an optical fiber by tightly fitting around the optical fiber, for a quick connection.

According to an additional aspect of the present invention, the light-transmitting shell is formed of a material which changes color after exposure to UV light, thus indicating that the diffuser has been used and must be disposed.

According to an additional aspect of the present invention, the material is a thermoplastic polyurethane (TPU).

According to an additional or an alternative aspect of the present invention, the shell comprises a diaphragm formed of a material which changes color after exposure to UV light, thus indicating that the diffuser has been used and must be disposed.

According to an additional aspect of the present invention, the material is a thermoplastic polyurethane (TPU).

According to an additional aspect of the present invention, a surface of the optical fiber, which forms contact with the fluid, is machined to form a lens, for improved light diffusion.

The present invention successfully addresses the shortcomings of the presently known configurations by providing substances, devices, methods, and kits for photo-sterilization of a root canal, prior to and when performing endodontics, as well as periodically as post-endodontic prophylactic measures. The root-canal filling includes a light-transmitting element, operative as a diffuser, and methods are provided for communicating light to the diffuser, for disinfecting the walls of the root canals, by photo sterilization. The diffuser may be formed of silicone polymers, synthetic fused silica, quartz, or the like, and may be surrounded by a light-transmitting sealer. The diffuser may be incorporated with an endodontic post, or a specially designed post, which may be transparent and (or) hollow. In a preferred embodiment, the diffuser is formed of a light transmitting conical shell of Cyclic Olefin Copolymers (COC), filled with a fluid such as air, distilled water, or silicone oil. The COC shell is particularly advantageous as it is flexible, unbreakable, has high light transmission, conforms to the contours of the root canal, and is rather inexpensive to produce.

Additionally, the present invention relates to intracorporeal photo-sterilization of the internal walls of a catheter.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In case of conflict, the patent specification, including definitions, will control. In addition, the materials, methods, and examples are illustrative only and not intended to be limiting.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a cross-sectional view of a tooth;

FIGS. 2A-2M schematically illustrate the steps in root canal therapy;

FIGS. 3A-3C schematically illustrate light apparatus, in accordance with preferred embodiments of the present invention;

FIGS. 4A-4C schematically illustrate methods for disinfecting the inner dentine walls of a tooth, during root canal therapy, in accordance with a preferred embodiment of the present invention;

FIGS. 5A-5H schematically illustrate a process of photo-sterilization in endodontics, in accordance with a preferred embodiment of the present invention;

FIGS. 6A-6P schematically illustrate diffusers, in accordance with several preferred embodiments of the present invention;

FIGS. 7A-7D schematically illustrate diffusers, in accordance with another embodiment of the present invention;

FIGS. 8A-8C schematically illustrate a diffuser, in accordance with another embodiment of the present invention;

FIG. 9 schematically illustrates a diffuser, in accordance with another embodiment of the present invention;

FIGS. 10A-10C schematically illustrate a light-transmitting sealer, operative as a diffuser, in accordance with another embodiment of the present invention;

FIGS. 11A-11D schematically illustrate diffusers, for situations in which the whole crown needs restoration, in accordance with other embodiments of the present invention;

FIGS. 12A-12B schematically illustrate a ring diffuser, in accordance with other embodiments of the present invention;

FIGS. 13A-13F schematically illustrate photo-sterilization with optical fibers, in accordance with another embodiment of the present invention;

FIGS. 14A-14M schematically illustrate a diffuser, in accordance with a preferred embodiment of the present invention.

FIGS. 15A-15E schematically illustrate light transmission as a function of diffuser geometry, in accordance with several embodiments of the present invention;

FIGS. 16A and 16B are graphical and tabular representations, respectively, of measured transmittance values of UV light, through human dentine, as a function of time;

FIGS. 17A-17C schematically illustrate kits of devices and substances for photo-sterilization of a root canal;

FIGS. 18A-18E schematically illustrate a single-bacterial-layer, UV irradiation test;

FIGS. 19A-19D illustrate single-bacterial-layer, UV-irradiation-test experimental results for different types of bacteria, irradiated as described in conjunction with FIGS. 18A-18D;

FIGS. 20A-20D schematically illustrate a multi-bacterial-layer, UV irradiation test;

FIGS. 21A-21H schematically illustrate an intra-canal UV irradiation test, using a diffuser, in accordance with the present invention;

FIGS. 22A-22B illustrate intra-canal UV irradiation tests for Streoptococcus Fecalis and general dog tooth plaque; and

FIGS. 23A-23C schematically illustrates a method for intracorporeal photo-sterilization of an internal wall of a catheter, in accordance with the present invention.

### DESCRIPTION OF THE PREFERRED EMBODIMENTS

The present invention is of substances, devices, methods, and kits for photo-sterilization of a root canal, prior to and when performing endodontics, as well as periodically as post-endodontic prophylactic measures. The root-canal filling includes a light-transmitting element, operative as a diffuser, and methods are provided for communicating light to the diffuser, for disinfecting the walls of the root canals, by photo sterilization. The diffuser may be formed of silicone polymers, synthetic fused silica, quartz, or the like, and may be surrounded by a light-transmitting sealer. The diffuser may be incorporated with an endodontic post, or a specially designed post, which may be transparent and (or) hollow. In a preferred embodiment, the diffuser is formed of a light transmitting conical shell of Cyclic Olefin Copolymers (COC), filled with a fluid such as air, distilled water, or silicone oil. The COC shell is particularly advantageous as it is flexible, unbreakable, has high light transmission, conforms to the contours of the root canal, and is rather inexpensive to produce.

Additionally, the present invention relates to intracorporeal photo-sterilization of the internal walls of a catheter.

The principles and operation of the substance and methods according to the present invention may be better understood with reference to the drawings and accompanying descriptions.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

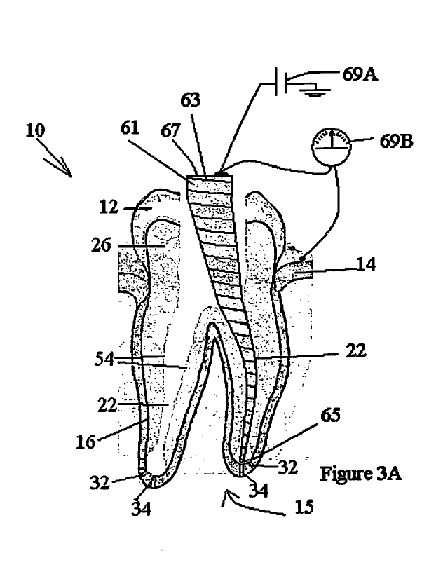

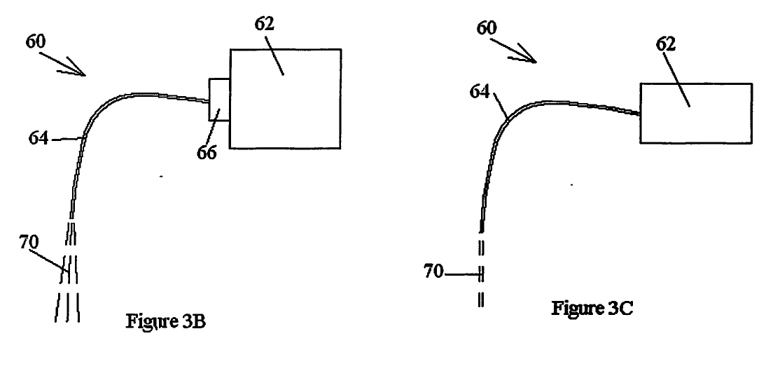

Referring now to the drawings, FIG. 3A-3C schematically illustrate preparatory work to photo-sterilization of a root canal, and photo-sterilization of a root canal prior to performing endodontics, in accordance with preferred embodiments of the present invention.

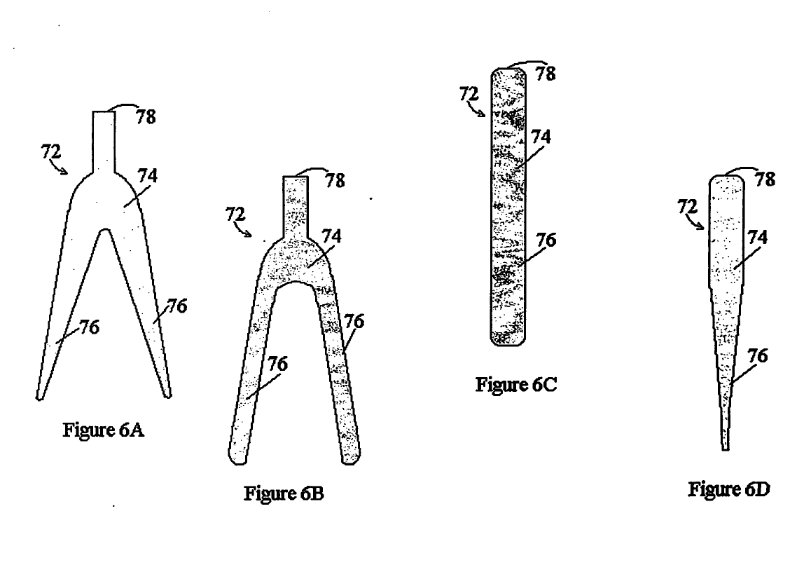

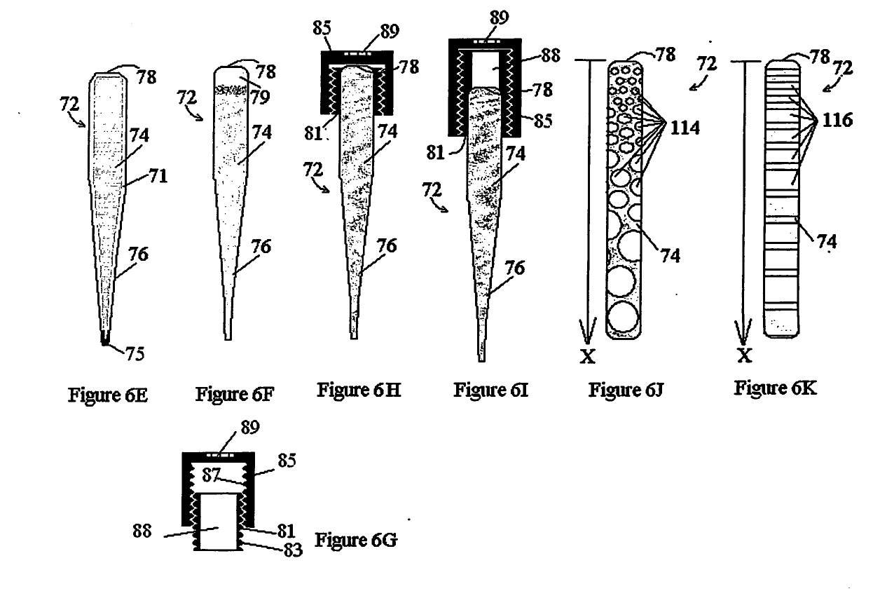

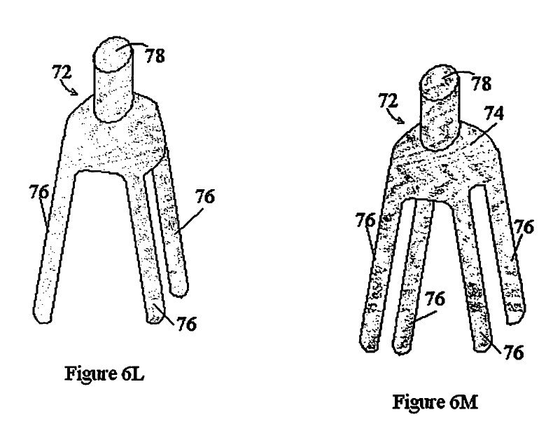

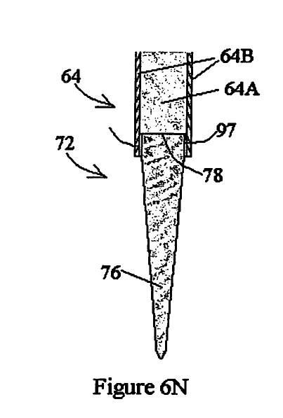

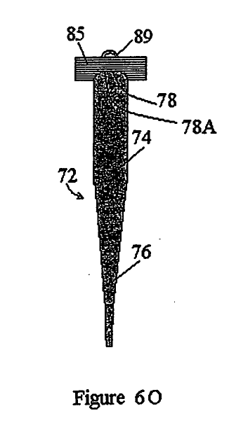

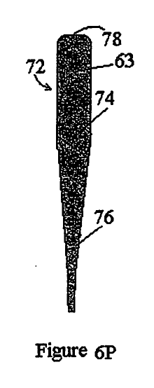

FIG. 3A schematically illustrates the preparatory work to photo-sterilization of root canal 22. In essence, before UV light is applied to a root canal for photo-sterilization, it is necessary to ensure that there is a dentine barrier between the root canal and the live tissue of jawbone 15. Accordingly, a flexible device 61, for example, a diffuser 72, as taught in conjunction with FIG. 6D, hereinbelow, may be used. A metal conducting wire 63 may be wound around device 61, from a broad proximal end 67 to a tip 65.

Device 61 may be inserted to root canal 22, while wire 63 may be connected to a power source 69A at proximal end 67. An amp-meter 69B is connected to wire 63 at proximal end 67 and to gum 14.

Wire 63 spirals around device 61, spanning the length and width of root canal 22. If a perforation in the dentin exists along the root canal walls, current will flow to gum 14, and be detected by amp-meter 67B.

Thus, the detection of current by amp-meter 69B indicates that photo-sterilization should not be performed until the perforation is sealed.

FIG. 3B and 3C schematically illustrate photo-sterilization of root canal 22, prior to performing endodontics, using with light apparatus 60, in accordance with preferred embodiments of the present invention.

As seen in FIG. 3B, apparatus 60 includes a light source 62, an optical fiber 64, and an optical element 66, operative to couple light source 62 and optical fiber 64. Light 70 is emitted from optical fiber 64. Light source 62 is preferably a UV light source. Alternatively, another light source, as known, may be used. For example, light source 62 may be a light diode (LED), for producing light for example, at 130 nm, 380 nm, or 480-630 nm. Alternatively, light source 62 may be a deuterium lamp, for producing light at about 160-400 nm. Alternatively, light source 62 may be an arc lamp, for example, of xenon or mercury, for producing light of between about 200 and about 2500 nm.

Alternatively, as seen in FIG. 3C, light source 62 is a laser. Preferably, the laser produces light in the ultraviolet range. Alternatively, visible light, or infrared light may be used. In accordance with the embodiment of FIG. 3C, optical element 66 need not be used.

Light source 62 may be, for example, an Nd Yag laser, for producing light of 1060 nm, 530 nm, or the 265 nm, a CO₂ laser, for producing light of 10600 nm, an F₂ laser, for producing light of 157 nm, an Excimer laser, for producing light of 193 nm, a He—Cd laser, for producing light of 442 nm, an N₂ laser, for producing light of 337.1 nm, an HeNe laser, for producing light of 633 nm, or an Argon laser, for producing light at about 488-514 nm. Alternatively, another gas laser, as known, may be used.

Alternatively, a diode-pumped, solid-state laser, as known, may be used. Additionally, it may be of a variable wavelength. For example, A GaN violet diode laser may be used, for producing light at about 400 nm. Alternatively, a UV tunable laser, such as Dye Laser, Excimer, or OPO may be used, for producing light in the range of 220-320 nm.

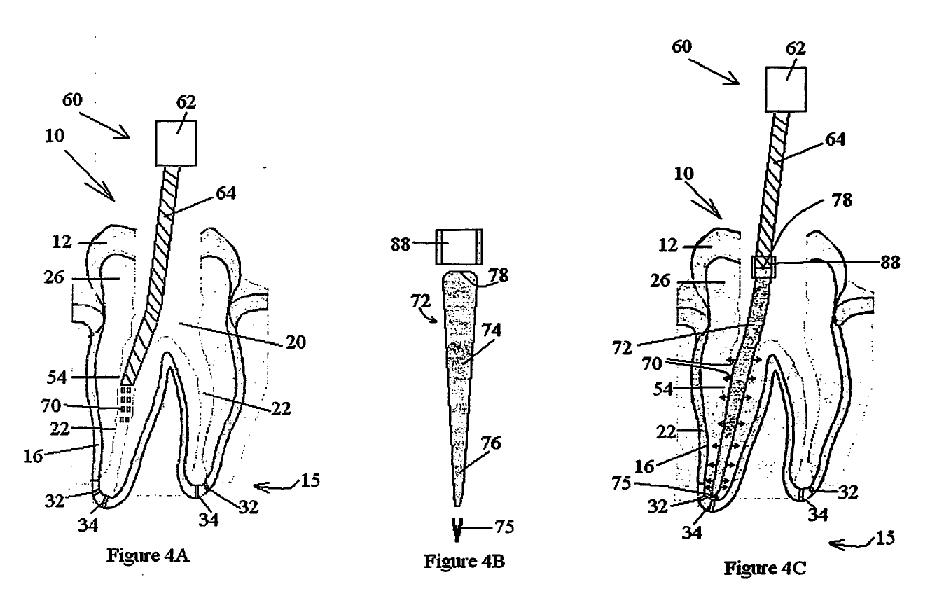

Referring now to the drawings, FIGS. 4A-4C schematically illustrate methods of root-canal photo-sterilizing, in accordance with the present invention.

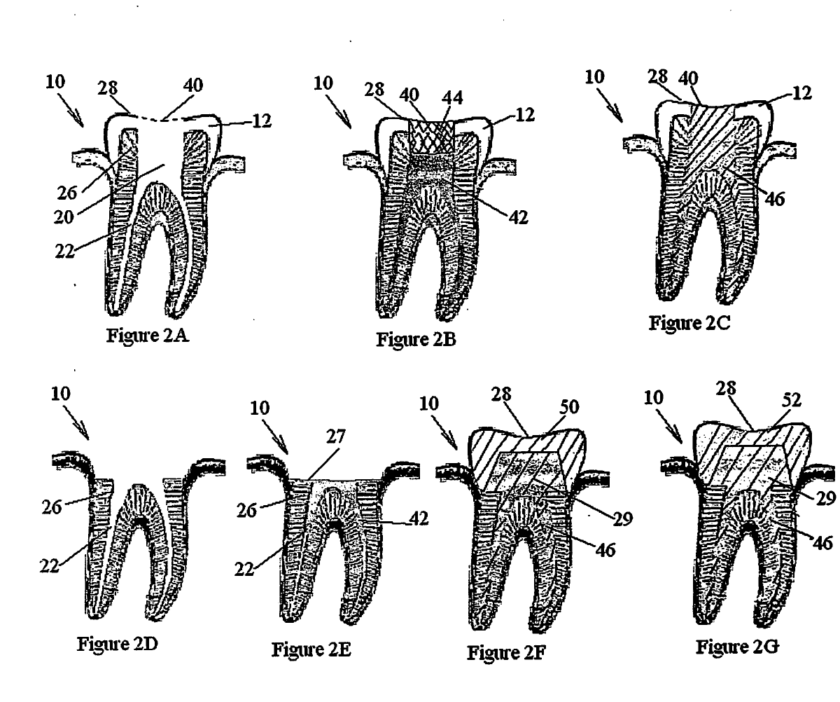

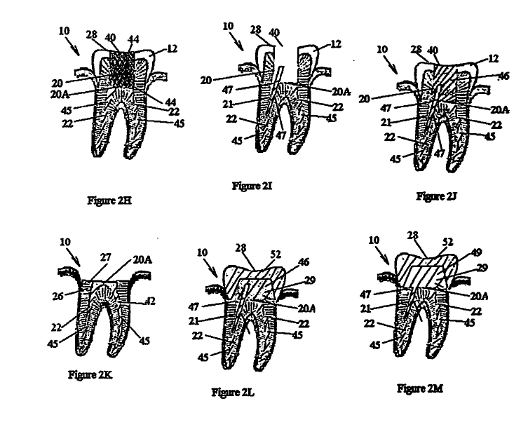

FIG. 4A illustrates a photo-sterilization process, in accordance with a first embodiment of the present invention. Optical fiber 64 of apparatus 60 is used to shine light 70 on dentine walls 54 of pulp chamber 20 and root canals 22, as a photo-sterilization process—for disinfecting walls 54. The photo-sterilization process may be additional to, or in place of a chemical-medicinal process that is commonly used (For example, as seen in FIGS. 2B and 2E). Additionally, the photo-sterilization process may lead to complete or partial sterilization of the dentine walls.

Since dentine 26 is practically a dead tissue, photo-sterilization, which may harm live tissue, is uniquely advantageous here; the only live tissue, which may be harmed by it, is a bacterium. However, it would be desirable for the light to strike the dental walls at a right angle. Additionally, accessory canals 32 and root-end openings 34 should be avoided, so as not to harm the live tissue jawbone 15. In order to meet these criteria, a diffuser may be used.

FIGS. 4B illustrates a diffuser 72, having at least a single branch, adapted for insertion into tooth 10 and operable to transmit light 70, preferably, by random walk for photo-sterilization of the dentine walls 54 of dentine 26.

Preferably, diffuser 72 is formed of a flexible material 74, for example, a silicone polymer. Its overall length may be between about 8 mm and about 25 mm, its proximal diameter may be between about 0.5 mm and about 2 mm, and the distal diameter may be, between about 0.1 mm and about 0.7 mm. It will be appreciated that these values serve as mere examples. Other values, which may be higher or lower, may similarly be used. It will be further appreciated that the actual dimensions of diffuser 72 may vary with the particular application. Specifically, these values apply to humans. It will be appreciated that the invention is also applicable to veterinary medicine, for example, in treating apes, where different dimensions may be required.

Diffuser 72 may include an optical-grade proximal surface 78, adapted for light coupling with apparatus 60. Furthermore, diffuser 72 may include a light coupler 88, formed for example, as a metal tube, for example, of titanium or stainless steel, having a wall thickness of between about 0.1 mm and about 0.5 mm, a length of between about 1.5 mm and about 4 mm, and an inner diameter of between about 0.2 mm and about 2 mm. It will be appreciated that these values serve as mere examples. Other values, which may be higher or lower, may similarly be used. It will be appreciated that another light coupler, as known, may be used. Alternatively, no light coupling is used.

Preferably, the inner diameter of light coupler 88 is just slightly larger than the diameter of surface 78, and light coupler 88 may partly slide over diffuser 72, as a sleeve, to form an overlap with diffuser 72, for example, for about 0.5 mm. Light coupler 88 may be glued to diffuser 72 at the region of overlap. Alternatively, the inner diameter of light coupler 88 is substantially the same as the diameter of surface 78, or somewhat smaller, and light coupler 88 may be arranged directly over surface 78, or glued to it.

Additionally, the inner walls of light coupler 88 may be coated, so as to minimize reflection.

Additionally or alternatively, an index matching paste or oil, such as silicone paste or silicone oil may be applied to surface 78, to improve light transmission between diffuser 72 and optical fiber 64.

Diffuser 72 may further include a distal shield 75, opaque to light 70, in order to prevent light 70 from reaching the live tissue of jawbone 15, through accessory canals 32 and root-end openings 34. Distal shield 75 may be, for example, a shoe formed of gold, titanium, or stainless steel, preferably, glued to the distal end of diffuser 72.

After diffuser 72, light coupler 88, and distal shield 75 are assembled, they are placed in tooth 10, which has been cleaned of its pulp and prepared for disinfection. It will be appreciated that diffuser 72 may be used also without light coupler 88 and (or) without distal shield 75.

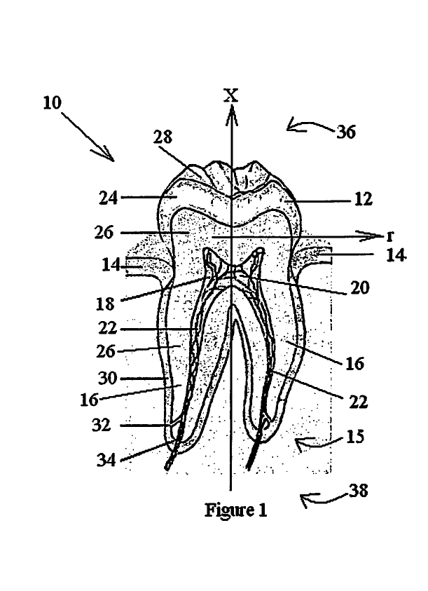

As seen in FIG. 4C, optical fiber 64 of apparatus 60 is coupled to diffuser 72, for example via light coupler 88, for shining light 70 on dentine walls 54. Because light 70 is emitted from diffuser 72 by random walk, it strikes dentine walls 54, generally at a right angle. In other words, although light 70 enters diffuser 72 along the X-axis (FIG. 1), the structure of diffuser 72 is such that light 70 exits it generally in the r direction.

Preferably, the light is in the ultraviolet range, preferably at between about 240 and about 270 nm, striking walls 54 with an intensity of between about 3 and about 300 mJ/cm2. Alternatively, other wavelengths and light intensities may be used, for example, as described hereinabove, in conjunction with FIGS. 3B and 3C.

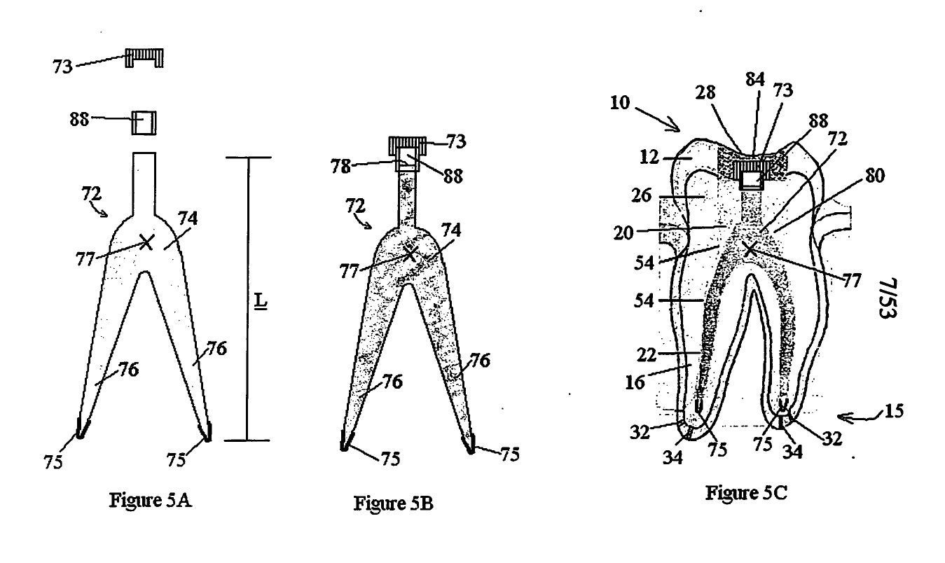

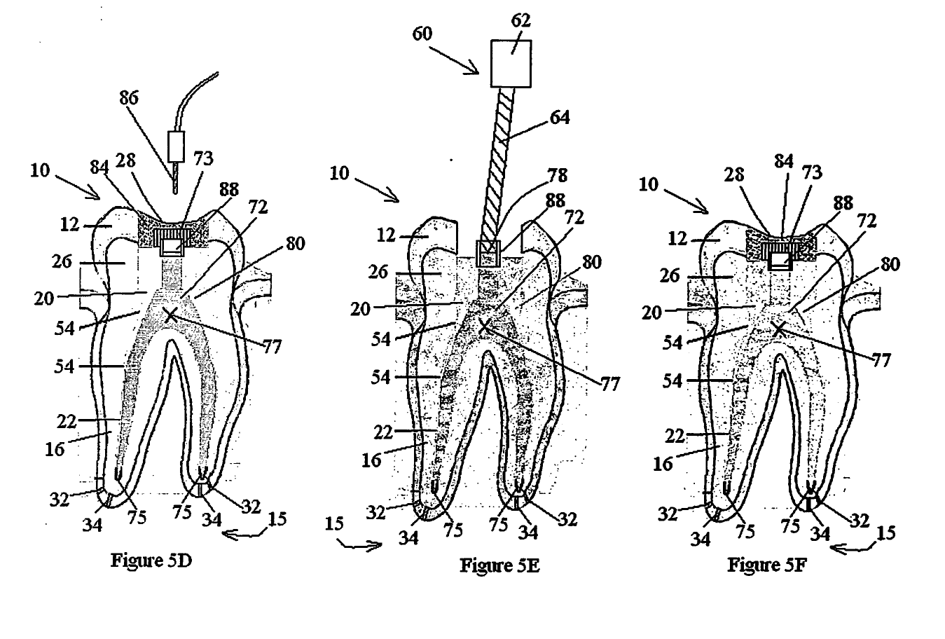

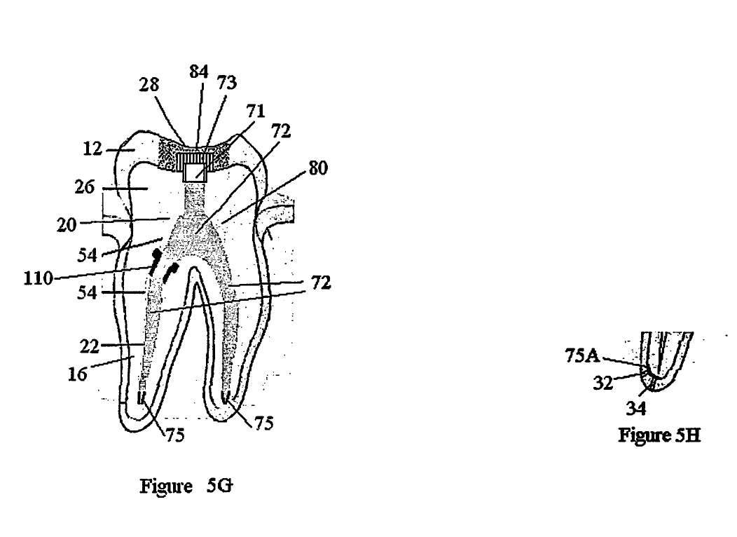

Referring further to the drawings, FIGS. 5A-5H schematically illustrate substances, devices and process of photo-sterilization in endodontics, in accordance with a preferred embodiment of the present invention.

As seen in FIGS. 5A and 5B diffuser 72 may have two branches 76, each preferably shaped generally as a cylindrical cone. An overall length L of diffuser 72 may be between about 5 mm and about 20 mm, its proximal diameter may be between about 0.5 mm and about 2 mm, and the distal diameter of each branch 76 may be, between about 0.1 mm and about 0.7 mm. It will be appreciated that these values serve as mere examples. Other values, which may be higher or lower, may similarly be used. It will be further appreciated that the actual dimensions of diffuser 72 depend on the tooth into which it is to be inserted.

Diffuser 72 may further include optical-grade proximal surface 78, and light coupler 88. In order to protect optical-grade proximal surface 78, a tightly fitting removable cap 73, formed for example, of silicone or natural rubber may be used over light coupler 88, or directly over proximal surface 78

Diffuser 72 may further include distal shields 75, which are preferably opaque to light 70, in order-to prevent light 70 from reaching the live tissue of jawbone 15, through accessory canals 32 and root-end openings 34. Distal shields 75 are preferably opaque also to x-rays, so that the presence of diffuser 72 will be clearly visible on an x-ray image of tooth 10.

Diffuser 72 may further include an additional marking that is visible on x-ray, operative as a fingerprint of a tooth diffuser. The additional marking may be, for example, a star or a cross 77, that informs dental professionals that tooth 10 includes a light diffuser.

After diffuser 72 is assembled, as seen in FIG. 5B, it is placed in tooth 10, that has been cleaned of its pulp, prepared and disinfected.

As seen in FIG. 5C, a light-transmitting sealer 80 is then used to fill and seal the gap that is formed between diffuser 72 and walls 54. Preferably, sealer 80 is formed as a mixture, comprising: 1. an adhesive, selected from the group consisting of silicone polymers, silica, silicate, and a combination thereof; and 2. a filler, selected from the group consisting of fumed silica, quartz particles, barium sulfate, ring-opening polymers, and a combination thereof. The mixture includes between about 2% and about 50% of the filler. Preferably, sealer 80 is applied as a viscous fluid, which is then cured.

At this point, light 70 may be applied, for photo-sterilization, for example, as described hereinabove, in conjunction with FIG. 4C.

After photo-sterilization, a conventional filling 84 is applied to crown 12, to restore chewing surface 28. Conventional filling 84 may be, for example, composite 46, described hereinabove, in conjunction with FIGS. 2C and 2F-2G.

In accordance with the present invention, diffuser 72 may be formed of the following materials, alone or in combinations:
1. silicone polymers, which preferably, do not include aliphatic rings, for example, poly-deimethylsiloxanes;
2. synthetic fused silica;
3. quartz;
4. poly-olefins, for example, polyethylene, polypropylene or their copolymers;
5. none-crystalline polyolefin, for example, Halar (ethylene-chlorotrifluororethylene), and TPX.

In accordance with the present invention, sealer 80 may be formed of at least two ingredients, a first material, operative as an adhesive, and a second material, operative as a filler, wherein the filler may comprise between about 2 and about 50% of the mixture.

The first material, or adhesive, may be formed of the following materials, alone or in combinations:
1. silicone Polymers, preferably of a neutral RTV silicone, which preferably is aliphatic;
2. silica; and
3. silicate.

The second material, or filler, may be formed of the following materials, alone or in combinations:
1. fumed Silica;
2. quartz particles—these increase the diff-using effect of light, and reduce the overall shrinkage of sealer 80, when curing;
3. barium sulfate, preferably as nano-particles, which are transparent to UV light, due to their small size, but are radio-opaque;
4. ring opening polymers, which expand upon polymerization and increase their volume, so that combining them with the first material, reduces the overall shrinkage of sealer 80, when cured, for example, alicylic Spiro ortho carbonates, and ionic base epoxies; and
5. biocompatible nano-particles, formed, for example, of gold, titanium and the like.

FIGS. 5D-5F schematically illustrate the method of photo-sterilization of a root canal, performed as a periodic, post-endodontic prophylactic measure. A recommended schedule for periodic photo-sterilization may be, for example, once every year, or once every two years.

As seen in FIG. 5D, periodically, after the completion of the endodontic treatment, conventional filling 84 is removed from crown 12, for example, with a drill bit 86. Cap 73 is then removed, exposing light coupler 88.

As seen in FIG. 5E, optical fiber 64 of apparatus 60 is coupled with diffuser 72, via light coupler 88, for performing photo-sterilization of walls 54 of root canal 22 and pulp chamber 20.

Light 70 (FIG. 3B) is transmitted from optical fiber 64 through diffuser 72 and sealer 80, by random walk. Striking walls 54 generally at a right angle, light 70 disinfects them.

Preferably, the light is in the ultraviolet range, preferably at between about 240 and about 270 nm, string walls 54 with an intensity of between about 3 and about 300 mJ/cm2. Alternatively, other wavelengths and light intensities may be used, for example, as described hereinabove, in conjunction with FIGS. 3B and 3C.

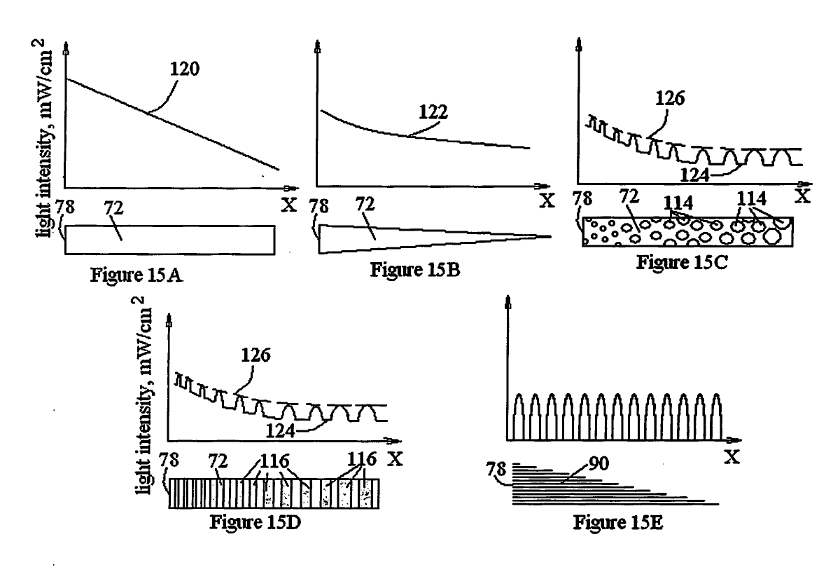

The intensity of light 70 decreases with increased distance from surface 78. However, diffuser 72 may be designed for a generally even light distribution along walls 54, as will be described hereinbelow, in conjunction with FIGS. 6D, 6J and 6K, and FIGS. 15B-15D.

As seen in FIG. 5F, after the completion of the photo-sterilization process crown 12 is again filled with conventional filling 84, restoring chewing surface 28.

FIG. 5G schematically illustrates tooth 10, in which a hollow endodontic metal support 110 provides strength to the root canal filling. Support 110 may be formed of titanium, a titanium alloy, or another high-strength, biologically compatible material. In accordance with the present invention, support 110 may be hollow, and diffuser 72 may be inserted through it.

FIG. 5H schematically illustrates a distal shield 75A, opaque to light 70, in order to prevent light 70 from reaching the live tissue of jawbone 15, through accessory canals 32 and root-end openings 34. Unlike distal shield 75 of FIG. 4B, which is mounted on the diffuser, distal shield 75A is applied as an opaque filling, directly to the bottom of the tooth canal, and may be, for example, a gold coating.

Referring further to the drawings, FIGS. 6A-6P schematically illustrate diffusers 72 in accordance with several preferred embodiments of the present invention.

As seen in FIG. 6A, diffuser 72 may be formed of flexible material 74, and be designed for a tooth of two roots. Diffuser 72 may thus include two branches 76, each shaped as a generally cylindrical cone. Preferably, diffuser 72 includes optical-grade proximal surface 78, adapted for light coupling with apparatus 60 (FIGS. 3B-3C). Diffuser 72 may thus be shaped generally as a cylinder, of a length of between about 5 and about 20 mm and a proximal diameter of between about 0.5 and about 2.0 mm.

As seen in FIG. 6B, diffuser 72 may include two branches 76, each shaped generally as a cylinder, having a diameter between about 0.2 and about 2.0 mm.

As seen in FIG. 6C, diffuser 72 may be formed of flexible material 74, shaped generally as a cylinder, of a length of between 5 and 20 mm and a diameter of between 0.2 and 2.0 mm.

As seen in FIG. 6D, diffuser 72 may include a proximal portion, shaped generally as a cylinder, and a single branch 76, shaped generally as a cylindrical cone. Alternatively, diffuser 72 may be shaped generally as a cylindrical cone, as taught by hereinabove, in FIG. 4B.

As seen in FIG. 6E, diffuser 72 may be formed of flexible material 74, such as a silicone polymer, coated by a thin layer 71 for example, of polypropylene, to a thickness of about 20 to about 30 microns, to increase its strength. Preferably, layer 71 may be fused with flexible material 74, so as to avoid a well-defined interface. Alternatively, coating 71 may be applied over material 74.

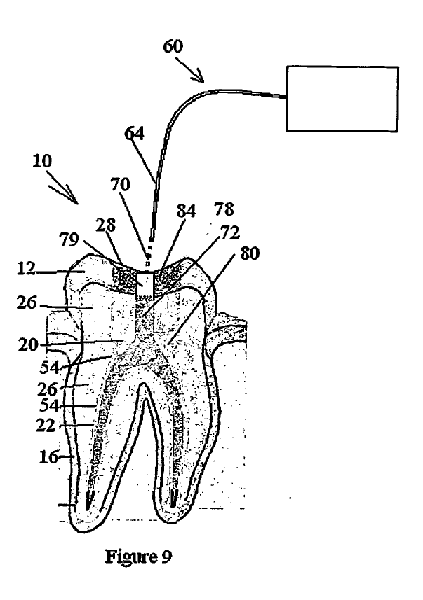

As seen in FIG. 6P, diffuser 72 may be formed of flexible material 74, such as a silicone polymer and a high-strength proximal portion 79, such as quartz, preferably fused with flexible material 74, so as not to form a well defined interface. High-strength proximal portion 79 may be used as a chewing surface, as will be described hereinbelow, in conjunction with FIG. 9.

As seen in FIGS. 6G and 6H, a metal sleeve 81, for example, of titanium, having an external thread 83, may be glued onto diffuser 72, at its proximal end. Additionally, a metal screw cap 85, for example, of titanium, having an internal thread 87, may be screwed onto metal sleeve 81, thus protecting optical-grade surface 78. A structure 89, such as an indentation, may be provided at the proximal surface of screw cap 85 for engaging with a tool (not shown) such as a screwdriver, or an Ellen key, for removing screw cap 85.

As seen in FIG. 6I, metal sleeve 81 is further operative as light coupler 88.

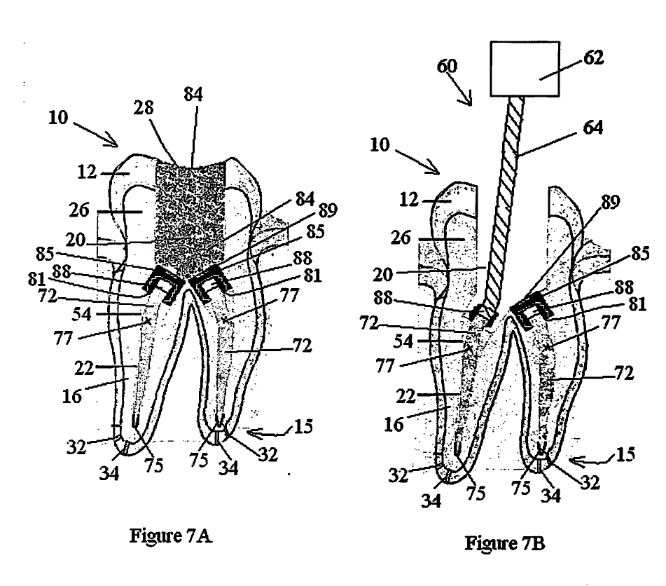

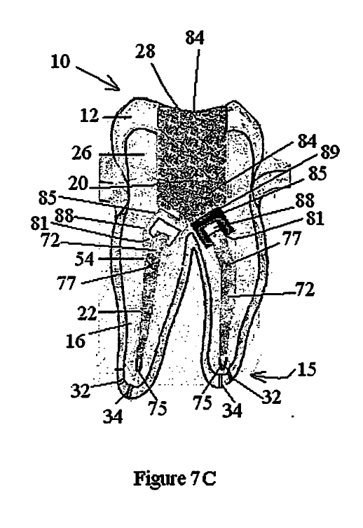

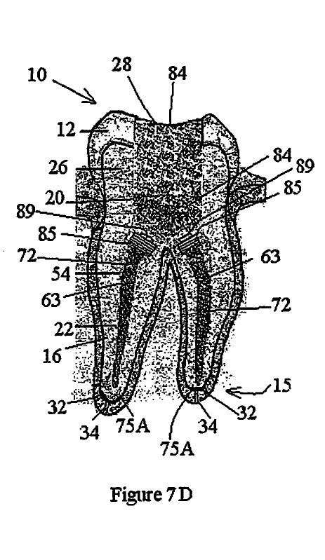

It will be appreciated that metal sleeve 81 and screw cap 85 may also be operative as a support, for providing strength to the root canal filling, as described in conjunction with FIGS. 5G and 7A.

As seen in FIG. 6J, the external surface of diffuser 72 may include a large plurality of pits 114, whose diameter increases with increasing values of X. For example, the diametric increase may be from between about 0.03 and about 0.05 mm at the proximal end, to between about 0.08 and about 0.15 mm, at the distal end. The depth of the pits may increase from about 0.02 at the proximal end to about 0.1 mm at the distal end. It will be appreciated that these are mere examples, and other values may similarly be used. Pits 114 are operative to even out the light intensity emitted from diffuser 72, along the X direction, as will be described hereinbelow, in conjunction with FIG. 15C.

As seen in FIG. 6K, the external surface of diffuser 72 may include a large plurality of channels 116, whose width increases with increasing values of X. For example, channel widths may increase from between about 0.10 and about 0.15 mm at the proximal end, to between about 0.20 and about 0.30 at the distal end. The depth of the channels may increase from about 0.02 at the proximal end to about 0.1 mm at the distal end. It will be appreciated that these are mere examples, and other values may similarly be used. Channels 116 are operative to even out the light intensity emitted from diffuser 72, along the X direction, as will be described hereinbelow, in conjunction with FIG. 15D.

As seen in FIG. 6L, diffuser 72 may be formed of flexible material 74, and be designed for a tooth of three roots. Diffuser 72 may thus include three branches 76, shaped generally as cylinders. Alternatively, three branches 76 may be shaped generally as cylindrical cones.

As seen in FIG. 6M, diffuser 72 may be formed of flexible material 74, and be designed for a tooth of four roots. Diffuser 72 may thus include four branches 76, shaped generally as cylinders. Alternatively, four branches 76 may be shaped generally as cylindrical cones.

As seen in FIG. 6N, optical fiber 64 may be machined so that core 64A and proximal surface 78 of diffuser 72 may be of substantially the same diameter, pressed against each other, and a coupling liquid 78A, such as silicone oil or water, preferably distilled, may be applied between them. Cladding 64B may extend and overlap diffuser 72, and be glued to diffuser 72, for example, with an adhesive 97, such as Norland optical adhesive 61 (UV cured), obtained form Norland Products, https://www.norlandprod.com/default.html. Alternatively, another adhesive may be used.

As seen in FIG. 6O, cap 85 may be press-fitted onto diffuser 72, and may further include structure 89, for example, a loop, which may be gripped, for example by tweezers, for lifting cap 85. Coupling liquid 78A, such as silicone oil or water, preferably distilled, may be applied between cap 85 and proximal end 78 of diffuser 72. Cap 85 may be of a biocompatible material, such as a metal or alloy, for example, SS, titanium or tantalum, or the like, or of another biocompatible material, for example, a polymer, natural rubber, silicone, cork, or the like.

As seen in FIG. 6P, wire 63 may be wrapped around diffuser 72, for identifying perforations in the dentine, prior to applying UV light, as taught in conjunction with FIG. 3A, hereinbelow.

Referring further to the drawings, FIGS. 7A-7D schematically illustrate schematically illustrate devices and a process of photo-sterilization in endodontics, in accordance with another preferred embodiment of the present invention.

Accordingly, two diffusers 72, as described hereinabove, in conjunction with FIG. 6I, and having at their proximal ends, metal sleeves 81, capped with metal screw caps 85, may be used in tooth 10 of two roots. Metal sleeves 81 may be further operative as light couplers 88, while screw caps 85 are intended to protect optical-grade surface 78. However, together, sleeves 81 and caps 83 provide strength to the root canal filling and may substitute for the supports that are commonly used, as described in conjunction with FIG. 5G.

Conventional filling 84 may be used over the capped diffusers.

As seen in FIG. 7B, periodic photo-sterilization of the root canals, performed as a post-endodontic prophylactic measure, requires removal of conventional filling 84. Screw caps 85 may then be unscrewed, exposing light couplers 88. Structure 89, such as an indentation, may be provided at the proximal surface of screw cap 85 for engaging with a tool (not shown) such as a screwdriver, or an Ellen key, for removing screw cap 85.

As seen in FIG. 7C, cap 85 may be as taught in conjunction with FIG. 6O, hereinbelow.

As seen in FIG. 7D, conducting wire 63 may be wrapped around diffuser 72, for identifying perforations in the dentine, prior to applying UV light, as taught in conjunction with FIGS. 3A and 6P, hereinbelow.

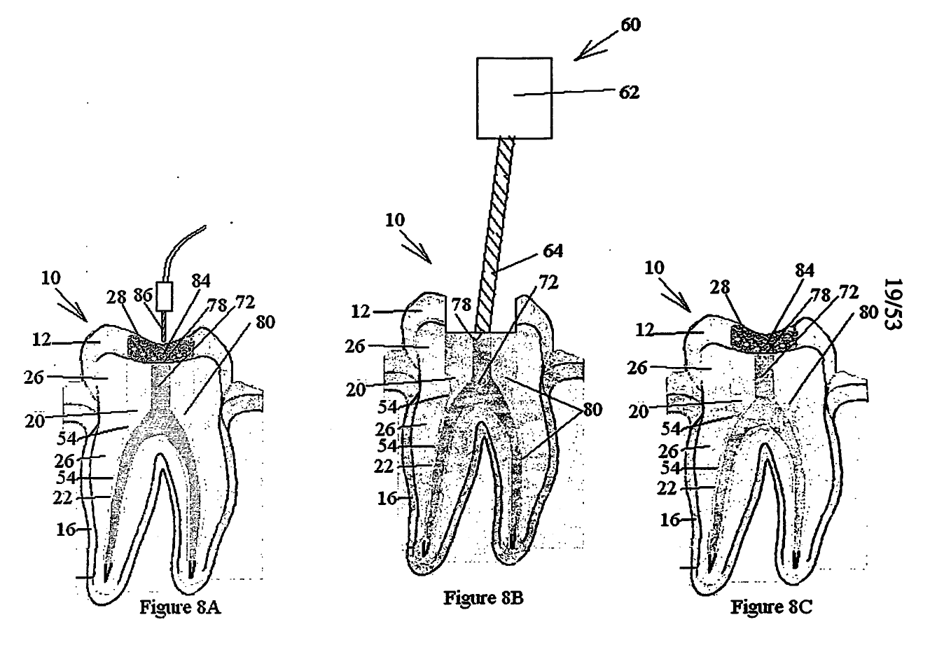

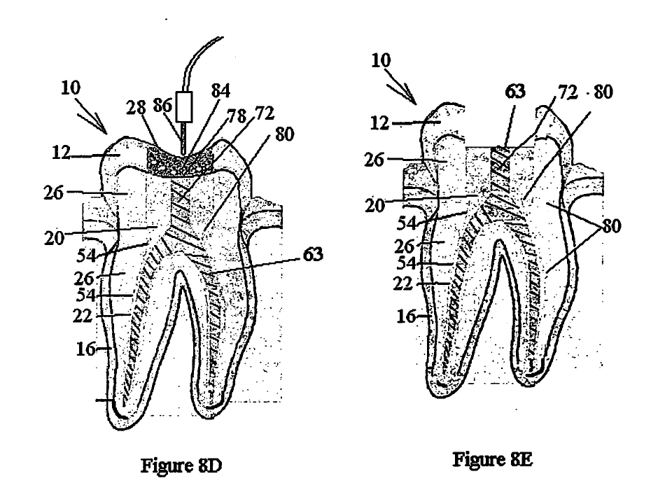

Referring further to the drawings, FIGS. 8A-8C schematically illustrate diffuser 72 in accordance with another embodiment of the present invention. Diffuser 72 may be inserted into tooth 10 without light coupler 88. Sealer 80 is then used to fill and seal the gaps between diffuser 72 and walls 54. Conventional filling 84 may be used to restore crown 12 and chewing surface 28.

As seen in FIG. 8A, for photo-sterilization, conventional filling 84 is removed by drilling, exposing proximal surface 78 of diffuser 72.

As seen in FIG. 8B, light 70 may be shined directly on surface 78 of diffuser 72. In accordance with the present embodiment, surface 78 is not optical grade, but it may be washed and dried prior to the photo-sterilization process. Alternatively, it may be prepared and polished just prior to the photo-sterilization process. In accordance with the present embodiment, light coupler 88 is not used. Alternatively, it may be attached to optical fiber 64 or placed on surface 78, prior to the photo-sterilization process.

As seen in FIG. 8C, after the photo-sterilization process, conventional filling 84 is used to-restore crown 12 and chewing surface 28.

Referring further to the drawings, FIG. 9 schematically illustrates diffuser 72 in accordance with another embodiment of the present invention. Diffuser 72 may be constructed as taught by FIG. 6F and inserted into tooth 10 without light coupler 88 and cap 73, while high-strength proximal portion 79, comprising proximal surface 78, forms a portion of chewing surface 28. Conventional filling 84 may be used around it. For photo-sterilization, light 70 is shone directly on exposed proximal surface 78. In accordance with the present embodiment, surface 78 is not optical grade, but it may be washed and dried prior to the photo-sterilization process. Alternatively, it may be prepared and polished just prior to the photo-sterilization process. In accordance with the present embodiment, light coupler 88 is not used. Alternatively, it may be attached to optical fiber 64 or placed on surface 78, prior to the photo-sterilization process. Alternatively, an index matching substance, such as silicone paste or silicone oil may be used.

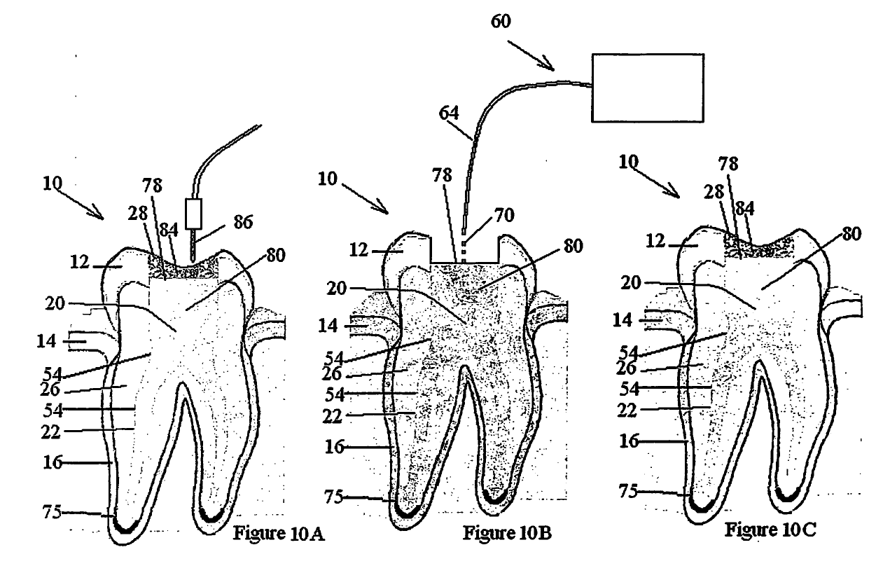

Referring further to the drawings, FIGS. 10A-10C schematically illustrate another embodiment, in accordance with the present invention, wherein diffuser 72 is formed simply of light-transmitting filling 80, forming the post, equivalent to post 46 (FIGS. 2C and 2G) and having proximal surface 78. Conventional filling 84 is used to restore chewing surface 28. For photo-sterilization, proximal surface 78 is exposed by drilling through conventional filling 84, and light is shone directly on proximal surface 78. Some surface preparation of proximal surface 78 may be performed prior to photo-sterilization. Light guide 88 may be placed on proximal surface 78. Additionally or alternatively, an index matching substance, such as silicone paste or silicone oil may be used.

In accordance with the present embodiment, shields 75 may be placed at the distal-most end of root canals 16.

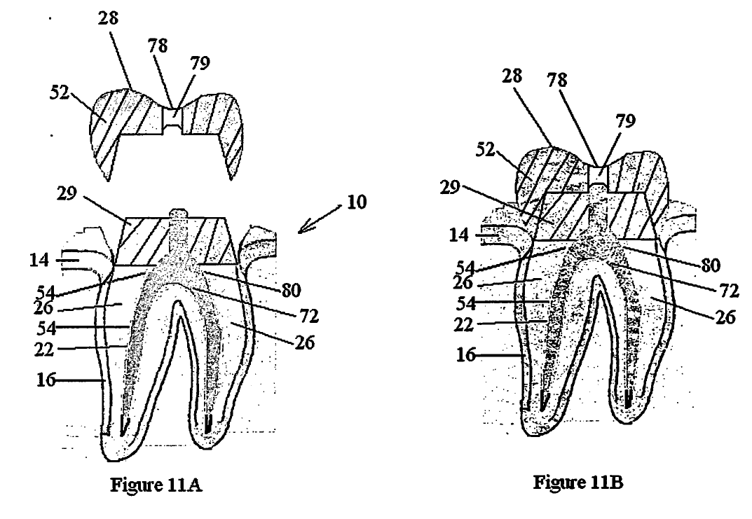

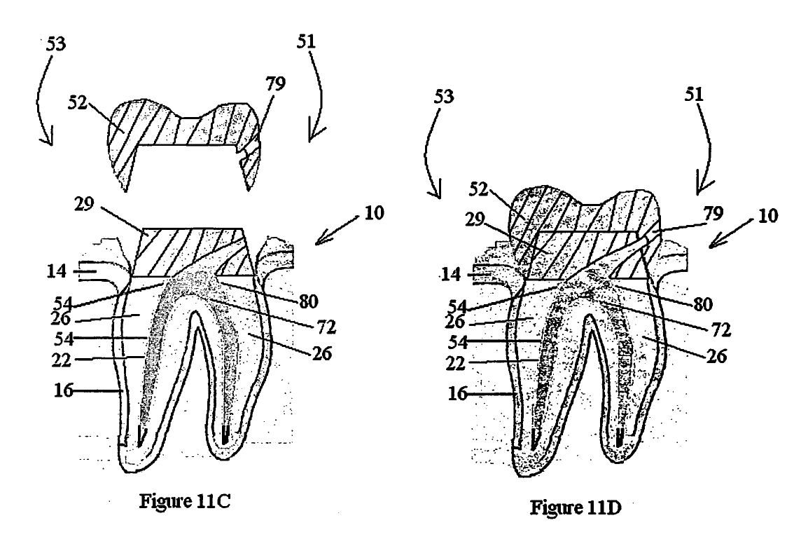

Referring further to the drawings, FIGS. 11A-11D schematically illustrate another embodiment, in accordance with the present invention, wherein crown 12 is badly damaged, and restored crown 52 is used in its place.

As seen in FIGS. 11A-11B, tooth 10 is reconstructed as follows. After cleaning and preparation, diffuser 72 is inserted into root canals 22 and light-transmitting sealer 80 is used to fill and seal the gaps between diffuser 72 and walls 54. Core 29 is then constructed, for example, of a conventional composite, which is cured with diffuser 72 embedded in it. A mold (not shown) is then taken of core 29.

The preparation of permanent crown 52 includes embedding within it, a high-strength light-transmitting element 79, formed, for example, of quartz, and comprising proximal surface 78. When placed over tooth 10, light-transmitting clement 79 couples with diffuser 72. During photo-sterilization, light 70 may be shone directly on proximal surface 78 of light-transmitting element 79. Some surface preparation of proximal surface 78 may be performed prior to photo-sterilization. Light guide 88 and (or) an index matching substance, such as silicone paste or silicone oil, may be used over surface 78. In accordance with the present embodiment, light-transmitting element 79 forms a portion of chewing surface 28.

Alternatively, as seen in FIGS. 11C-11D, light-transmitting element 79 may be arranged on a buccal side 51 or on a lingual side 53 of tooth 10, and diffuser 72 may be arranged to make contact with it. Thus, light-transmitting element 79 is less likely to be damaged by the chewing action.

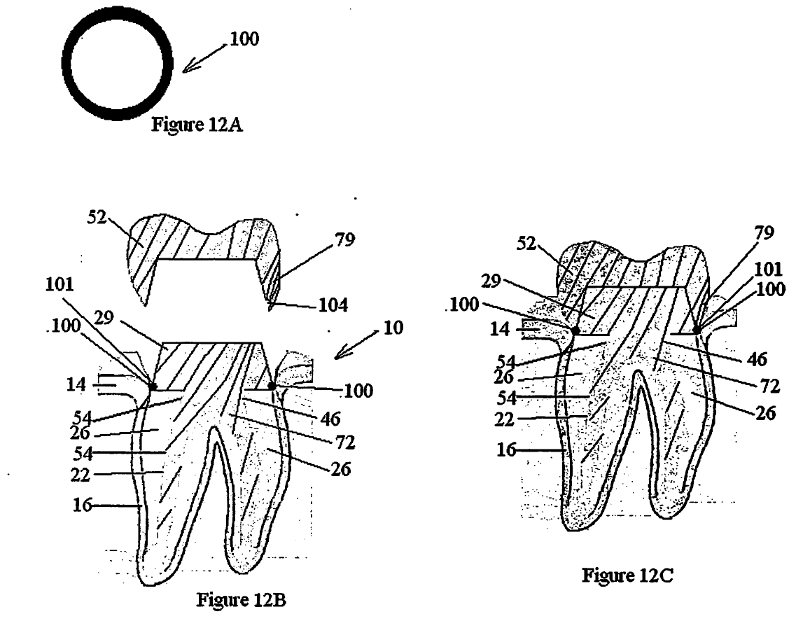

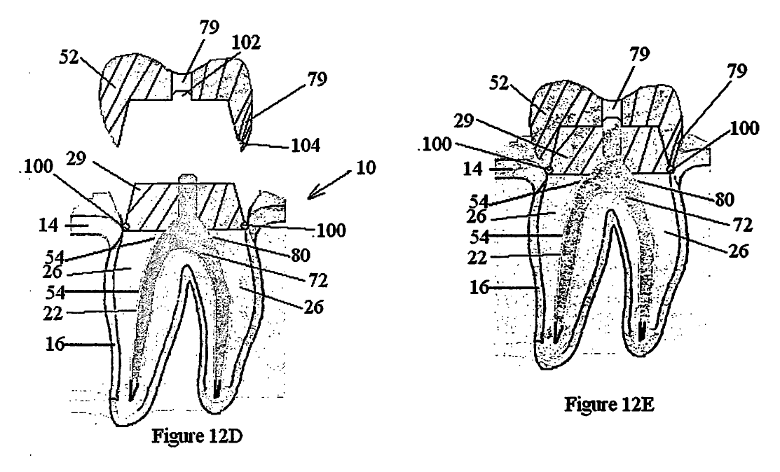

Referring further to the drawings, FIGS. 12A-12E schematically illustrate a ring diffuser 100, in accordance with another preferred embodiment of the present invention.

As seen in FIGS. 12A-12C, ring diffuser 100 is not intended for root canals 22. Rather, it is designed for an interface 101, between core 29, formed, for example, of conventional filling 46, permanent crown 52, and dentine 26, though which bacteria infiltrates. Bacteria may travel, for example, along the interface between core 29 and dentine 26, and down root canal 22. By placing a diffuser at the interface zone, and performing periodic photo-sterilization, via light-transmitting element 79, bacteria infiltration may be checked.

As seen in FIGS. 12D-12E, ring diffuser 72 may be used together with diffuser 72.

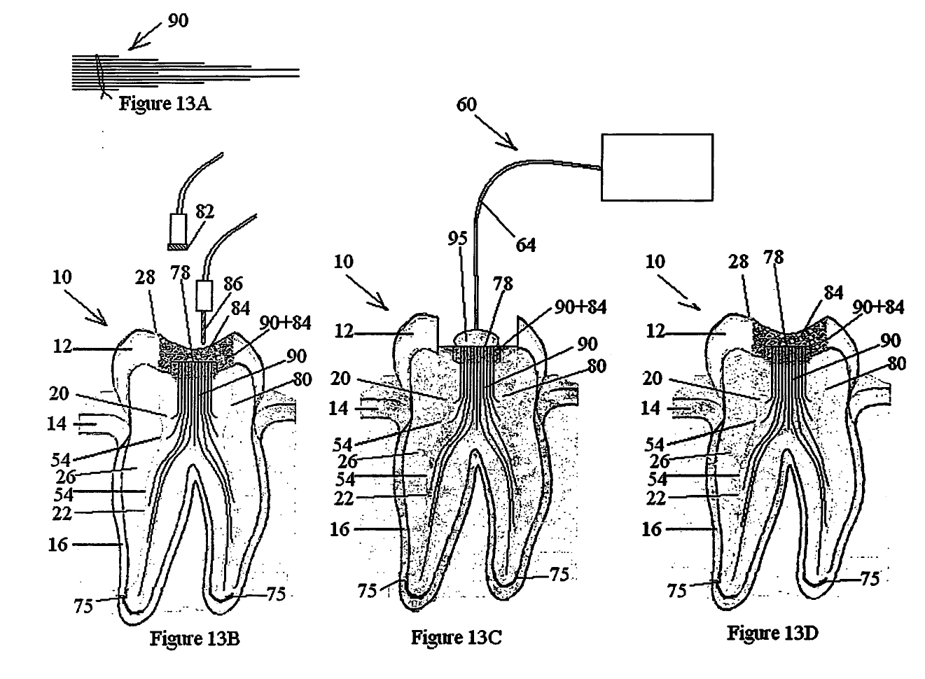

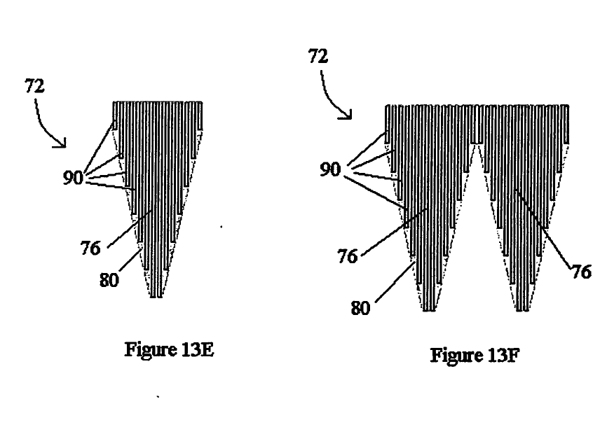

Referring further to the drawings, FIG. 13A-13F schematically illustrate another embodiment, in accordance with the present invention, wherein a plurality of optical fibers 90 of varying lengths is used, in place of diffuser 72.

In accordance with the present embodiment, plurality of optical guides 90 is inserted into pulp chamber 20 and root canals 22. Light-transmitting sealer 80 is then used to fill and seal the gap between optical guides 90 and walls 54. Above gum 14, conventional filling 84, such as a conventional composite, may be used, forming, at its proximal end, surface 78, which is high-strength and which may be polished, and which restores chewing surface 28.

Preferably, plurality of optical fibers 90 is of the same fiber as optical fiber 64.

For photo-sterilization, a polishing tool 82 may then be used to polish surface 78 and prepare it for light coupling.

Additionally or alternatively, an index matching substance, such as silicone paste or silicone oil may be used for light coupling.

In accordance with the present embodiment, shields 75 may be placed at the distal-most end of root canals 16.

FIGS. 13E and 13F illustrate diffusers 72 formed as pluralities of optical fibers 90, encased in light-transmitting sealer 80. These can then be inserted into root canals 22. FIG. 13E illustrates a situation of a single-branch diffuser, and FIG. 13F illustrates a situation of a double-branch diffuser.

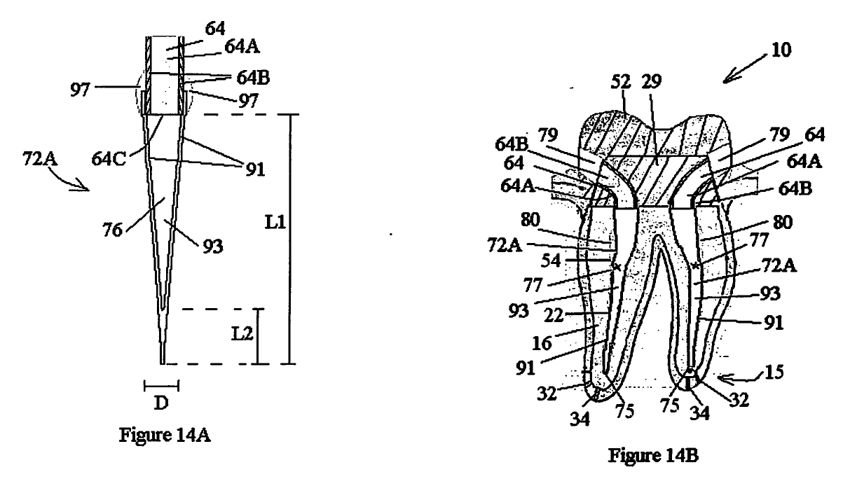

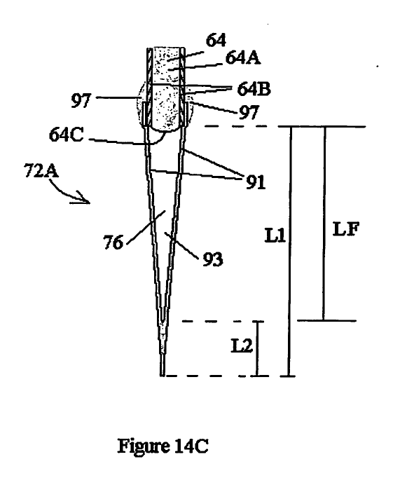

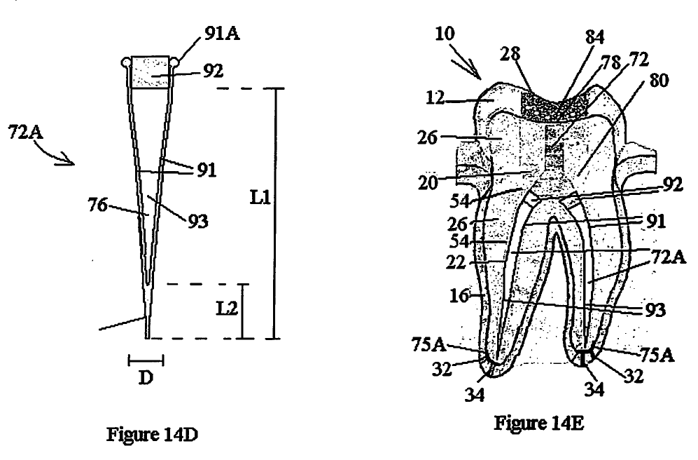

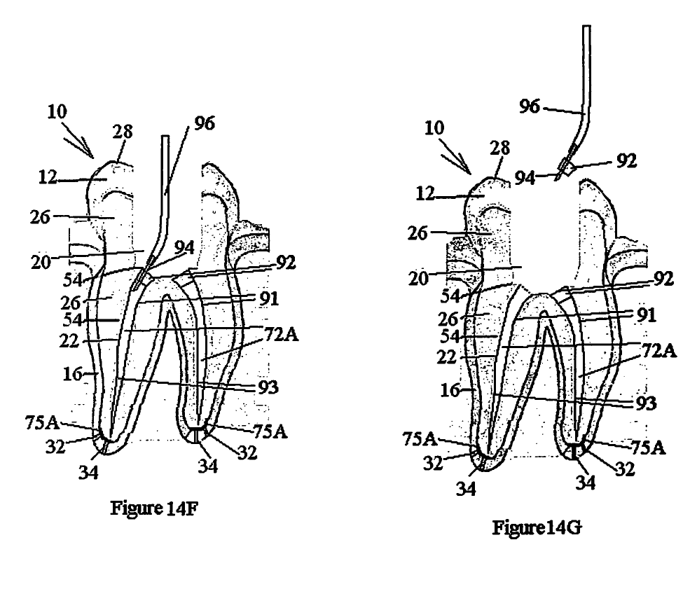

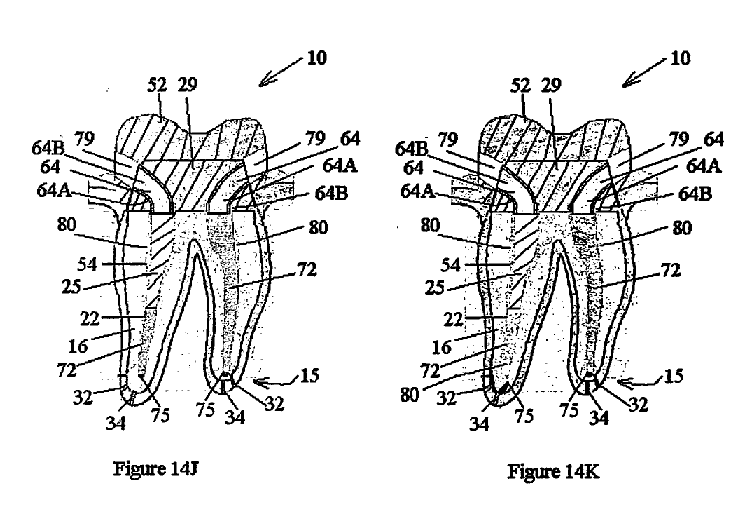

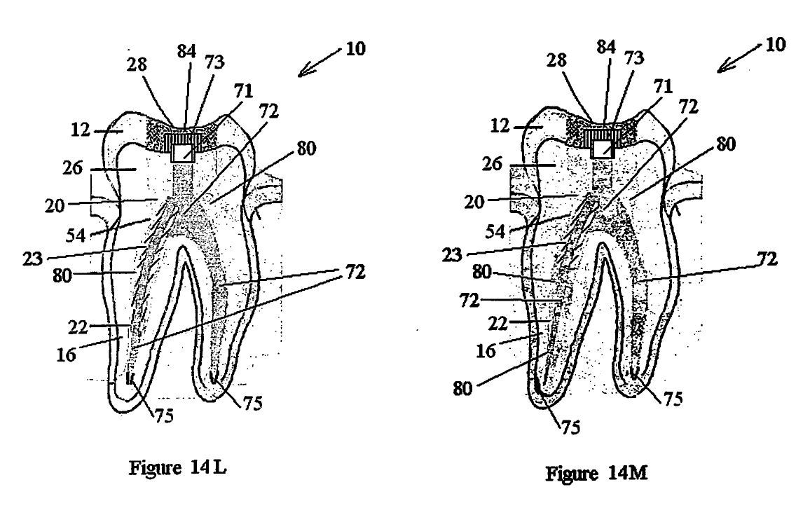

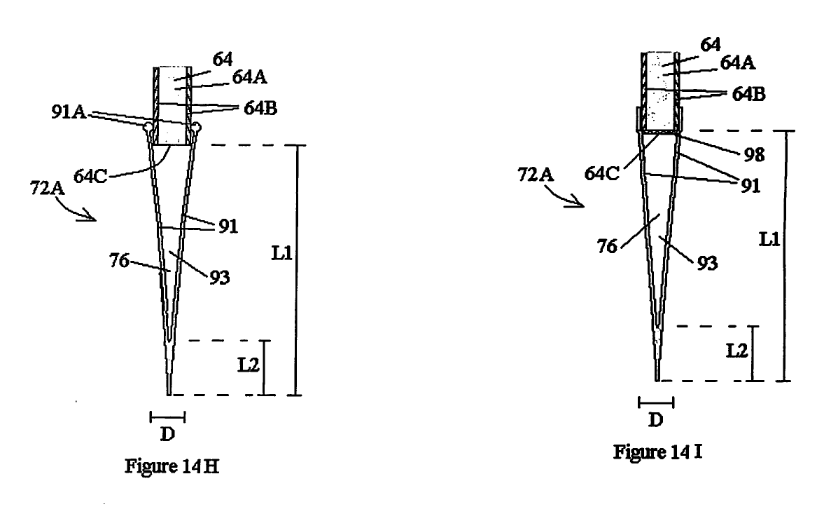

FIGS. 14A-14I schematically illustrate a diffuser 72A, in accordance with a preferred embodiment of the present invention.

As seen in FIG. 14A, diffuser 72A is formed as a light-transmitting shell 91, filled with a light-transmitting fluid 93.

Preferably, light-transmitting shell 91 is flexible, so as to adapt to the contours of root canal 22.

Additionally, light-transmitting shell 91 may be conical. It will be appreciated that other shapes, for example, adapted to include two or more branches may similarly be used.

Light-transmitting shell 91 may be formed of any thin plastic. But preferably, light-transmitting shell 91 is formed of a Cyclic Olefin Copolymers (COC), for example, produced by Ticona Company, http://www.ticona-eu.com/company/en/html/General.cfm.

More preferably, light-transmitting shell 91 is formed of COC 8007 Hi UV, which at a thickness of 3 mm, transmits 15% of the UV radiation at the wavelength which is preferred for photo-sterilization, 254 nm, and transmits substantially all the UV radiation of this wavelength at a thickness of about 0.2 mm.

Light-transmitting fluid 93 may be air, water, preferably distilled, or a light transmitting oil, such as silicone oil. Preferably, light-transmitting fluid 93 transmits substantially all the UV radiation at a thickness of about 10-20 mm.

A preferred length L1 of diffuser 72A for humans may be between about 8 and about 25 mm, and preferably about 10 and about 15 mm. It will be appreciated that diffuser 72A may be manufactured at a plurality of lengths, allowing the dentist to measure the required length and select an appropriate diff-user for it. Preferably, diffuser 72A includes a solid base of a length L2, of between about 0.2 and about 2.0 mm. The diameter D of diffuser 72A may be between about 0.5 mm and about 1.5 mm, at a proximal end with respect to an operator, and substantially 0.1-0.5 mm at a distal end. It will be appreciated that other dimensions, which may be larger or smaller, may similarly be used.

It will be appreciated that other dimensions may be used, for example, in veterinary medicine.

In a sense, the use of diffuser 72A is a major breakthrough in the use of diffusers for photo-sterilization of tight places, in vivo. Diffuser 72A is advantageous over other diffusers, for example, taught in conjunction with FIGS. 4B-13F, for the following reasons:
i. it is non-breakable, so there is no danger of a portion of the diffuser breaking off within the root canal;
ii. it substantially conforms to the shape of the root canal;
iii. its light transmittance is very high, compared to other diffusers;
iv. diffuser 72A need not include surface 78 (FIG. 6A). Rather, optical fiber 64 may be in direct contact with fluid 93;
v. the design of diffuser 72A is such that it may be inserted into very tight places and expanded in vivo; and
vi. diffuser 72A is rather inexpensive to make, by injection forming.

Diffuser 72A may be attached to optical fiber 64, having core 64A and cladding 64B, by extending shell 91 over cladding 64B and applying adhesive 97, such as Norland optical adhesive 61 (UV curing) of Norland Products, https://www.norlandprod.com/default.html, at the area of the overlap. Alternatively, another adhesive may be used.

Thus, the interface between fluid 93 and a surface 64C of optical fiber 64 forms proximal surface 78 of diffuser 72A.

It will be appreciated that this embodiment may be used either when embedding the diffuser within root canal 22, for post-endodontic prophylactic measures, as taught in conjunction with FIG. 14B hereinbelow, or when performing endodontics, as taught in conjunction with FIG. 4C, hereinabove.

FIG. 14B illustrates diffuser 72A within root canal 22. In accordance with a preferred embodiment of the present invention, enamel-like structure 52 is prepared as taught in conjunction with FIGS. 11A-11D, hereinbelow, and includes at least one quartz window 79, while optical fiber 64 is embedded within core 29. This arrangement enables a dentist to apply photo-sterilization through the restored crown. It will be appreciated that two diffusers 72A may be inserted in the two root canals.

As seen in FIG. 14C, surface 64C of optical fiber 64 may be machined as a lens so as to focus the light emitted from optical fiber 64. Preferably, a focal distance LF of surface 64C is substantially equal to L1. It has been found experimentally that when the light is thus focused, improved light diffusion is obtained. It will be appreciated that this embodiment may be used either when embedding the diffuser within root canal 22, for post-endodontic prophylactic measures, as taught in conjunction with FIG. 14B, or when performing endodontics, as taught in conjunction with FIG. 4C.

As seen in FIG. 14D, the connection between diffuser 72A and optical fiber 64 may be formed by an end ring 91A of polymeric shell 91, adapted to press against optical fiber 64. Additionally or alternatively, an “o” ring 91B may be used, to ensure press-fitting shell 91 against optical fiber 64. Preferably, the open end of diffuser 72A is about 0.6 mm in diameter, while optical fiber 64 is about 0.5 mm in diameter, so diffuser 72A may form a tight fit over optical fiber 64. In this manner, adhesive 97 need not be used. This method allows for a quick connection between diffuser 72A and optical fiber 64, either for performing photo-sterilization of a root canal, during endodontics (FIG. 4C), or for embedding in the root canal, as in FIG. 14B.

Alternatively, an embodiment analogous to that of FIGS. 7A-7C may be used.

Thus, as seen in FIG. 14E, a plug 92, preferably of a biocompatible material, such as a metal or alloy, for example, SS, titanium or tantalum, or the like, or of another biocompatible material, for example, a polymer, natural rubber, silicone, cork, or the like, may be inserted into diffuser 72A, in place of cap 85 (FIGS. 6H, 6O). Preferably, the plug is held tight by end ring 91A. Additionally or alternatively, “o” ring 91B may be used, to ensure press-fitting shell 91 against plug 92.

As seen in FIG. 14F, the plugged diffuser may be inserted into the root canal, in a manner similar to that taught in conjunction with FIG. 7C.

FIGS. 14G and 14H illustrate a manner of unplugging diffuser 72A, embedded in root canal 22, when it is desired to sterilize the root canal as a post-endodontic prophylactic measure.

As seen in FIG. 14G, the diffuser is uncovered by drilling through conventional filling 84, as taught in conjunction with FIG. 7B. A hyperdemic needle may then be inserted to plug 92, and diffuser 72A may be pressurized somewhat.

As seen in FIG. 14H, the elevated pressure in diffuser 72A causes plug 92 to pop out. It will be appreciated that frictional forces between plug 92 and the inner surface of shell 91 are relatively low, since shell 91 is a polymeric material.

FIG. 14I illustrates diffuser 72A, formed as light-transmitting shell 91, filled with light-transmitting fluid 93, for use with the embodiment of FIG. 4C, for initial sterilization of a root canal. As such, diffuser 72A is used only once, then disposed. Preferably, it is not transferred from one tooth to anther, even for the same person, in order not to transfer bacteria from one tooth to another.

Disposable diffuser 72A is designed for quick connection with optical fiber 64, as in FIG. 14D.

Additionally, diffuser 72A preferably includes a diaphragm 98, formed of a material which is substantially transparent to UV light, but which is discolored when exposed to UV light, so a discoloration in the diaphragm may indicate that the diffuser has been used, thus preventing repeated uses, for safety reason. Additionally or alternatively, light-transmitting shell 91 may be formed of a material which is substantially transparent to UV light, but which is discolored by the exposure. Some thermoplastic polyurethanes (TPUs) are transparent to UV and change color after UV exposure. For example, The aromatic isocyanate-based TPUs derived from methylene diphenyl diisocyanate will slowly form a conjugated species that is yellow on UV exposure.

It will be appreciated that diaphragm 98, which is discolored by exposure provides an additional safety measure. After discoloration, it blocks UV radiation. Thus, as the dental surgeon removes the diff-user from the tooth, there is little danger of exposure to UV light from the exposed diffuser, if the UV source was accidentally left on.

FIGS. 14J-14M schematically illustrate diffuser 72, incorporated with a post, taught in conjunction with FIGS. 2H-2M, in accordance with preferred embodiments of the present invention.

As seen in FIG. 14J, a post 25, made of a transparent material, such as quartz, may be used, and diffuser 72 is glued to post 25, at its apical end.

Alternatively, as seen in FIG. 14K, no diffuser is used in the root canal in which post 25 is inserted. Rather, transparent post 25 ends about midway the root canal, and transparent sealer 80 diffuses the light emitted from post 25.

Alternatively, as seen in FIG. 14L, a hollow and transparent post 23 may be used, and diffuser 72 may be passed through hollow post 23.

Alternatively, as seen in FIG. 14M, a short, hollow opaque post 23 may be used, and diffuser 72 may be passed through it. The segment of the root canal against hollow opaque post 23 may not receive light, but it is short and in the coronal portion of the root canal, which is less susceptible to residual infection.

It will be appreciated that the diffusers and posts of FIGS. 14J-14M may be fabricated as single units of diffuser and post, of various sizes. Alternatively, they may be fabricated separately, of various sizes.

Referring further to the drawings, FIGS. 15A-15E schematically illustrate light transmission as a function of diffuser geometry, in accordance with several embodiments of the present invention.

As seen in FIG. 15A, when the diffuser is formed generally as a cylinder, with no surface features, the diffused light intensity, which is emitted from it, falls, generally linearly with distance in the X direction. When it is desired that a large portion of walls 54 (FIGS. 4C and 5C) will experience an even light intensity, other geometries may be preferred.

As seen in FIG. 15B, diffuser 72 is formed generally as a cylindrical cone, leading to a more even light distribution as a function of X.

As seen in FIG. 15C, the external surface of diffuser 72 is covered with pits 114, whose diameters increase with increasing X values, as described hereinbelow, in conjunction with FIG. 6J. In practice, this geometry also leads to a more even light distribution, as a function of X.

As seen in FIG. 15D, the external surface of diff-user 72 is covered with channels 116, whose widths increase with increasing X values, as has been described hereinbelow, in conjunction with FIG. 6K. As in FIG. 15C, this geometry leads to a more even light distribution, as a function of X.

As seen in FIG. 15E, plurality of optical fibers 90 of varying lengths, emits light at peaks of substantially equal intensity, as has been described hereinbelow, in conjunction with FIGS. 13A-13D. This geometry also leads to a more even light distribution as a function of X

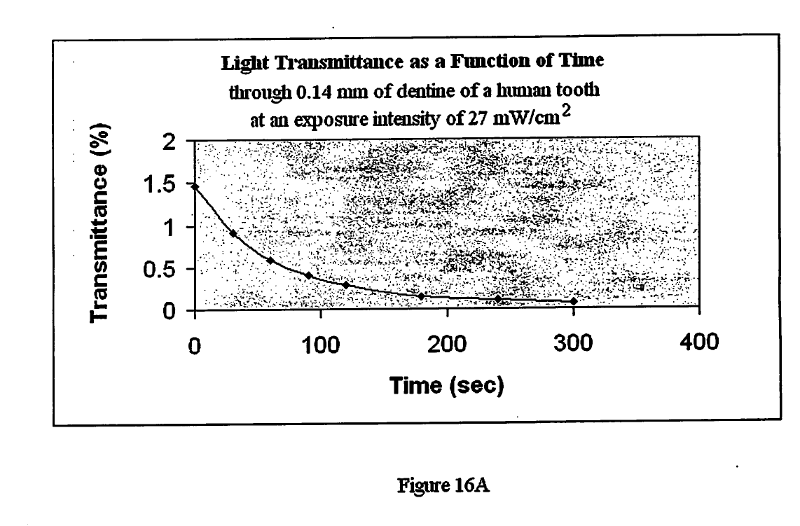

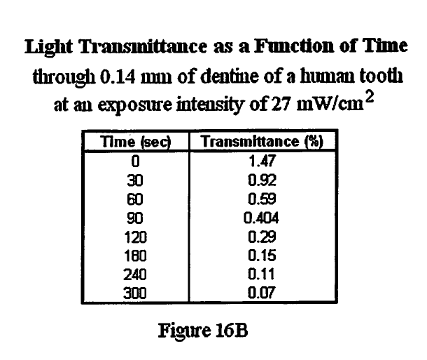

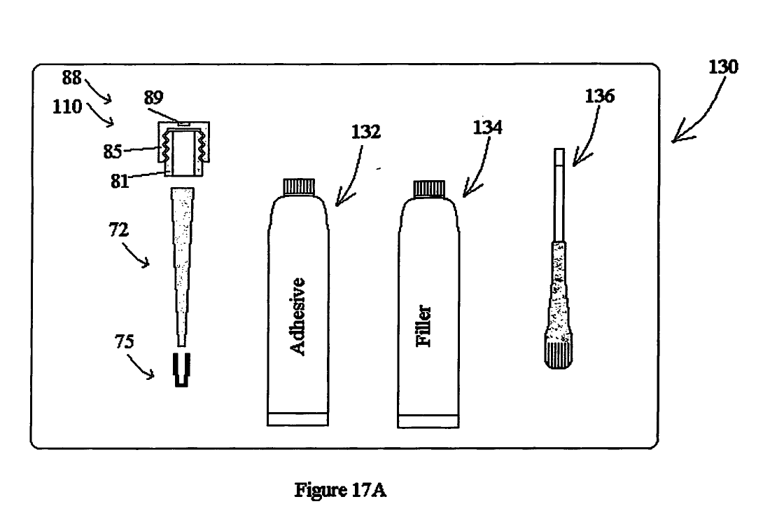

Referring further to the drawings, FIGS. 16A and 16B are graphical and tabular representations of measured transmittance values of UV light, through human dentine, as a function of time. The dentine layer was 0.14 mm. The light wavelength was 254 nm and its intensity was 27 mW/cm². As seen, the initial transmittance is less than 1.5%, and it falls rapidly with time. Thus, the present method of photo-sterilization poses little danger to gum and bone tissue.

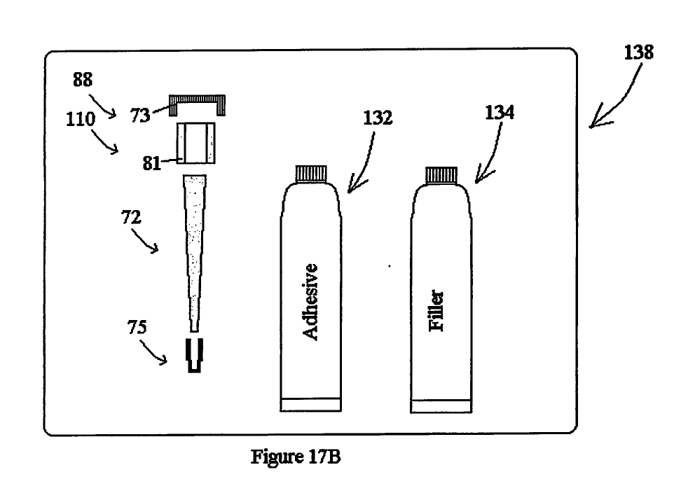

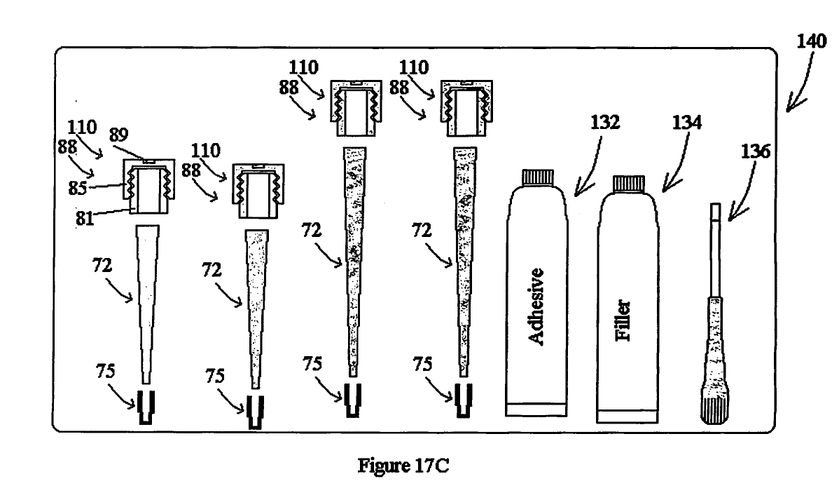

Referring further to the drawings, FIGS. 17A-17C schematically illustrate kits of devices and substances for photo-sterilization of a root canal.

FIG. 17A illustrates a photo-sterilization kit 130, comprising diffuser 72, and light coupler 88, formed as sleeve 81, and including protective screw cap 85, wherein sleeve 81 and screw cap 85, together, are also operative as support 110 (FIG. 5G), for providing strength to the root canal filling. Additionally, photo-sterilization kit 130 may include distal shield 75, a tube of adhesive 132, a tube of filler 134, and a tool 136, adapted to engage with indentation 89 of screw cap 85.

Alternatively, FIG. 17B illustrates a photo-sterilization kit 138, comprising diffuser 72, and light coupler 88, formed as sleeve 81 and having flexible protective cover 73 (FIG. 5A), wherein sleeve 81 may be also operative as support 110, for providing strength to the root canal filling. Additionally, photo-sterilization kit 138 may include distal shield 75, tube of adhesive 132, and tube of filler 134. Alternatively, adhesive 132 and filler 134 may be premixed and provided in a single tube.

FIG. 17C illustrates a photo-sterilization kit 140, comprising a plurality of diffusers 72, which may be of different sizes and shapes, each having light couplers 88, formed as sleeves 81, and including protective screw caps 85, which are also operative as supports 110. Additionally, photo-sterilization kit 140 may include distal shields 75, tube of adhesive 132, tube of filler 134, and tool 136, adapted to engage with indentation 89 of screw cap 85.

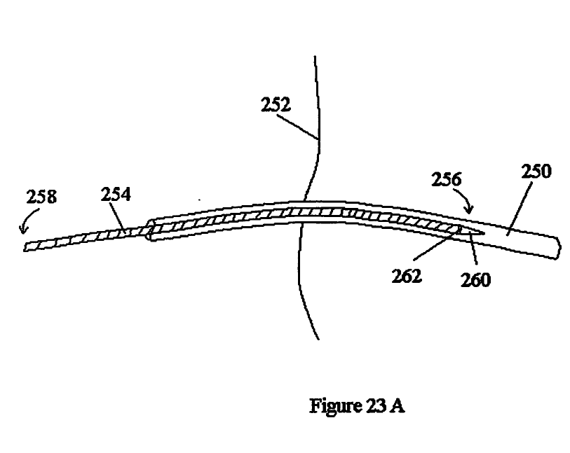

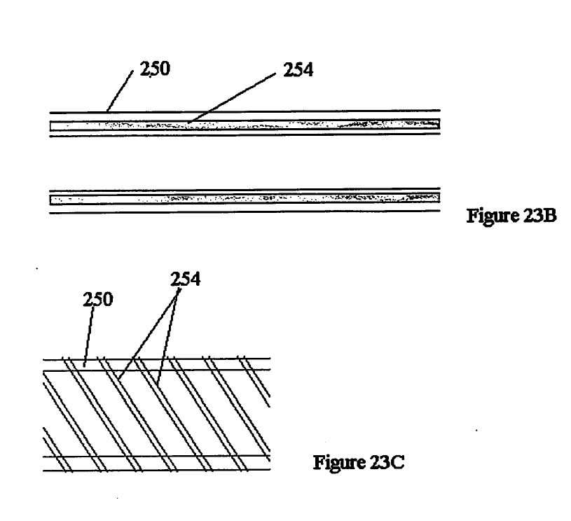

Referring further to the drawings, FIGS. 23A-23C schematically illustrate method for intracorporeal photo-sterilization of an internal wall of a catheter, in accordance with the present invention.

Accordingly, FIG. 23A illustrates an intracorporeal catheter 250, inserted through skin 252. An optical fiber 254 is inserted through catheter 250. Optical fiber 254 includes proximal and distal ends 256 and 268, with respect to an operator. Preferably, a diffuser 260 is coupled to optical fiber 254, through a coupling 262, at distal end 258. As optical fiber 254 is inserted into catheter 250, shining light at its internal wall, via diffuser 260, wherein the light is at a combination of wavelength and intensity for photo-sterilization, photo-sterilization of the internal wall of catheter 250 takes place.

Diffuser 260 may be a ball, a cone, or another shape, as known.

Preferably, catheter 250 is opaque, or semi opaque to the light, so that live tissue is not harmed by the photo-sterilization.

Preferably, the wavelength and intensity combination, the construction of the diffuser and the coupling with the optical fiber is as taught in conjunction with diffuser 72, hereinbelow.

Additionally or alternatively, as seen in FIGS. 23B and (or) 23C, catheter 250 may be formed of a double wall, and diffuser 254 may be inserted in the catheter's walls.

It is expected that during the life of this patent many relevant substances, devices, and methods for photo-sterilization will be developed and the scope of the term substances, devices, and methods for photo-sterilization is intended to include all such new technologies a priori.

As used herein the term “about” refers to ±30%.

Additional objects, advantages, and novel features of the present invention will become apparent to one ordinarily skilled in the art upon examination of the following examples, which are not intended to be limiting. Additionally, each of the various embodiments and aspects of the present invention as delineated hereinabove and as claimed in the claims section below finds experimental support in the following examples.

### EXAMPLES

Reference is now made to the following examples, which together with the above descriptions, illustrate the invention in a non limiting fashion.

### Example 1

### Single Bacteria Layer

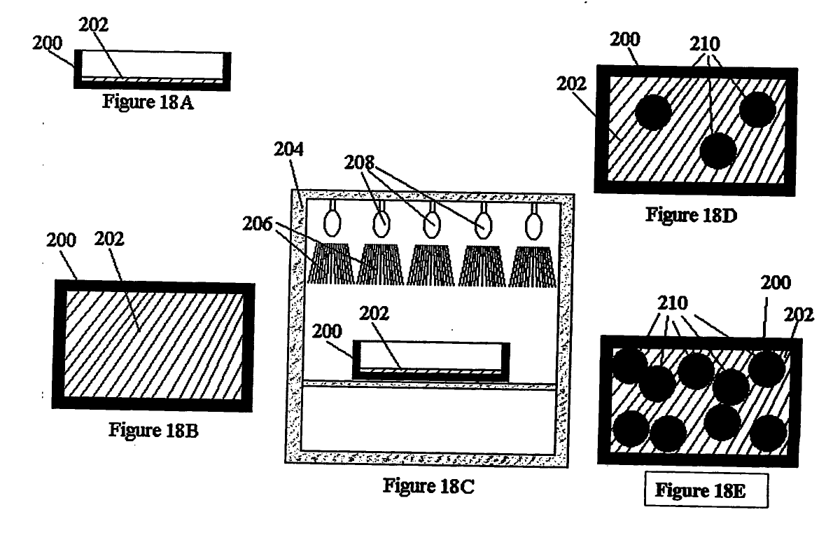

Referring further to the drawings, FIGS. 18A-18E schematically illustrate a single-bacterial-layer, UV irradiation test.

As seen in FIGS. 18A and 18B, illustrating side and top views respectively, a bottom of a petri dish 200 was covered with a highly diluted bacterium solution 202, to a thickness just sufficient to wet it. It was known by statistical evaluation, that at that thickness, bacterium solution 202 contained only a single layer of bacteria.

A plurality of petri dishes 200 were prepared in this manner, and one was kept as a control.

As seen in FIG. 18C, except for the control dish, each petri dish 200 was placed in a Bio-Link Irradiator 204, for irradiation under a UV light 206, produced by a series of mercury lamps 208.

Each petri dish was irradiated at a different irradiation density, for example, 0.001 Joul/cm², 0.002 Joul/cm², 0.003 Joul/cm², up to about 0.01 Joul/cm².

As seen in FIGS. 18D, after irradiation, the petri dishes were allowed to incubate for 24 hours, until bacterial colonies 210 were visibly observed. Each colony was formed by single bacterium that survived irradiation.

As seen in FIGS. 18E the control petri dish was similarly allowed to incubate for the same period of time, to provide a bacteria count when no irradiation takes place.

Percent Killing was defined as:

$$Percent Killing = \frac{number of bacterial colonies in an irradiated dish}{number of bacterial colonies in the control dish} \times 100$$

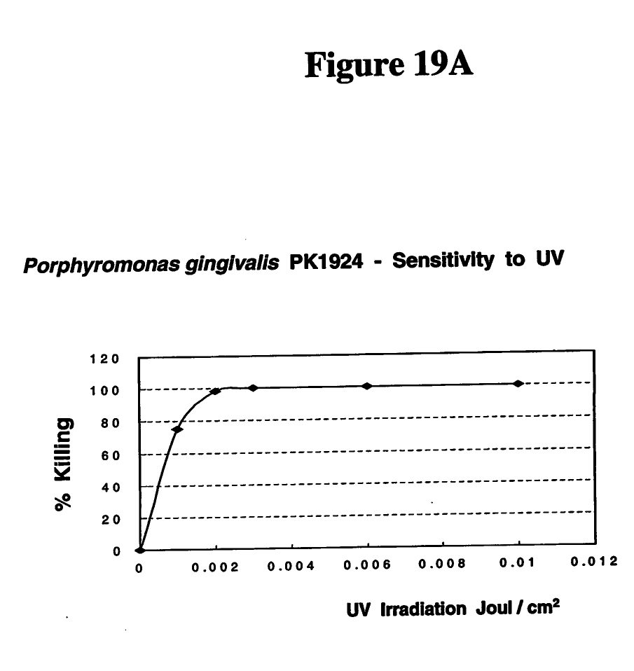

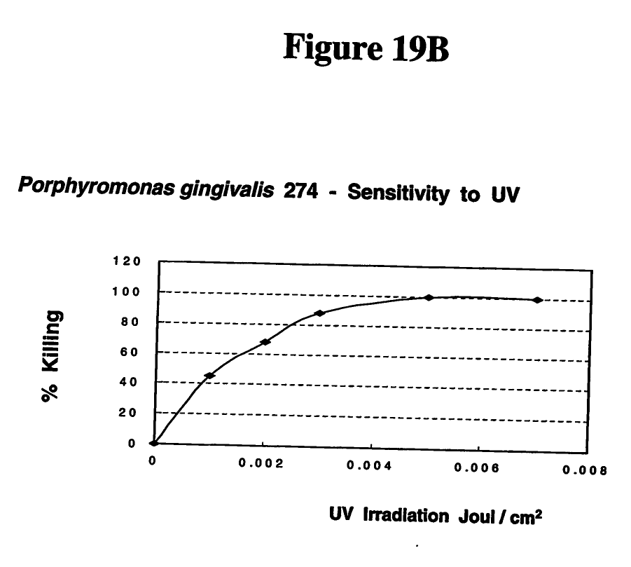

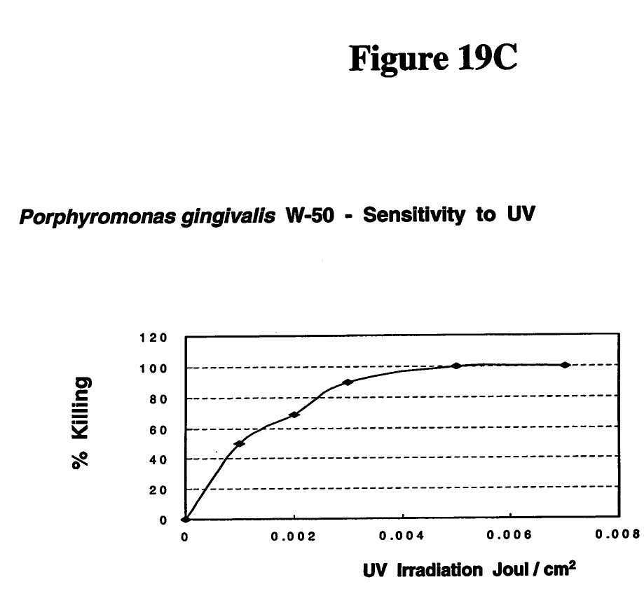

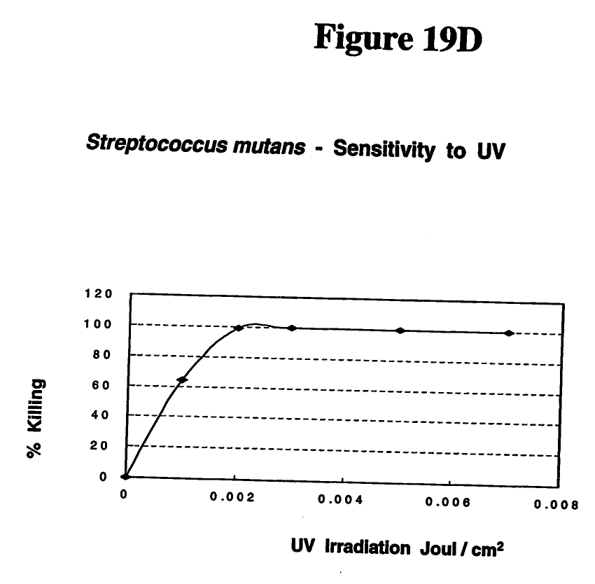

Referring further to the drawings, FIGS. 19A-19D illustrate single-bacterial-layer, UV-irradiation-test experimental results for different types of bacteria, irradiated as described in conjunction with FIGS. 18A-18D. Porphyromonas gingivalis PK1924 (FIG. 19A) were found to be the most sensitive bacteria to UV light; substantially 100% killing was reached at about 0.002 Joul/cm² of UV light, produced by the mercury lamp. Streptococcus mutans (FIG. 19D) were somewhat less sensitive, and about 0.003 Joul/cm² was required for substantially 100% killing. Porphyromonas gingivalis 274 (FIG. 19B) and Porphyromonas gingivalis W-50 (FIG. 19C) required over 0.005 Joul/cm², for substantially 100% killing.

### Example 2

### Multi Bacteria Layer

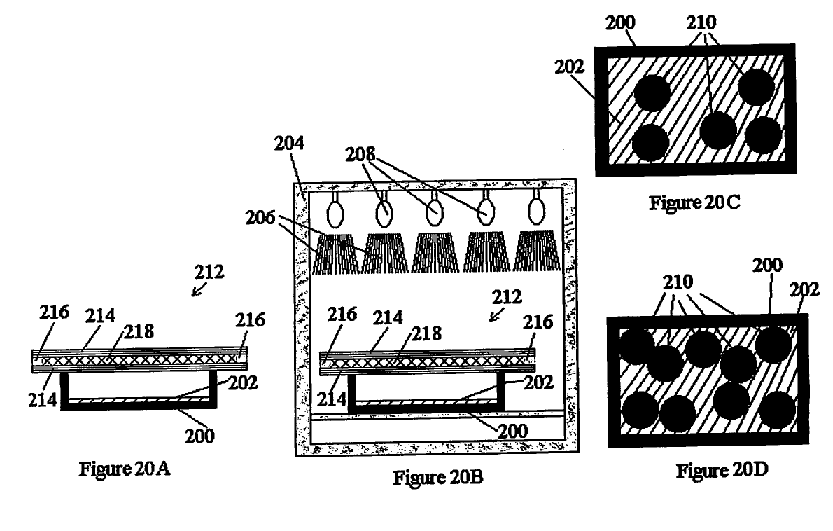

Referring further to the drawings, FIGS. 20A-20D schematically illustrate a multi-bacterial-layer, UV irradiation test. The purpose of the multi-bacterial-layer was to evaluate the protective effect (screening effect) of the outermost bacterial layers over inner bacterial layers, from irradiation.

As seen in FIG. 20A, to imitate the effect of protective bacterial layers, a multi-layer setup 212 was constructed as follows: petri dish 200, with highly diluted bacterium solution 202, to a thickness just sufficient to wet it, was covered with a second solution 218, of a height and concentration of several bacterial layers. Second solution 218 was placed in a glass container formed of top and bottom neutral density filters 214, whose absorption factor of UV light was known, so that the absorption effect of the glass container could be taken into account. Spacers 216 were glued to the two neutral density filters 212, and the inner space, defined therein, was filled with second solution 218.

Two multi-bacterial layer tests were conducted. In the first test, multi-layer setup 212 was constructed with a height of spacer 216 and a concentration of second solution 218 equivalent to two bacterial layers. In the second test, it was equivalent to four bacterial layers. For each of these, a plurality of multi-layer setups 212 were constructed, and one of each was kept as a control setup.

As seen in FIG. 20B, each multi-layer setup 212 (except for the control) was placed in Bio-Link Irradiator 204, for irradiation under UV light 206.

As seen in FIG. 20C, after irradiation, the petri dishes were allowed to incubate for 24 hours, until bacterial colonies 210 were visibly observed.

As seen in FIG. 20D the control petri dishes was similarly allowed to incubate for the same period of time.

After accounting for the effect of the glass filters and the medium of second solution 218, the experimental results showed a protection effect, of a factor of 5, for 2 layers of bacteria, and a protection effect, of a factor of 25, for 5 layers of bacteria.

### Example 3

### Intra-Canal UV Irradiation Test

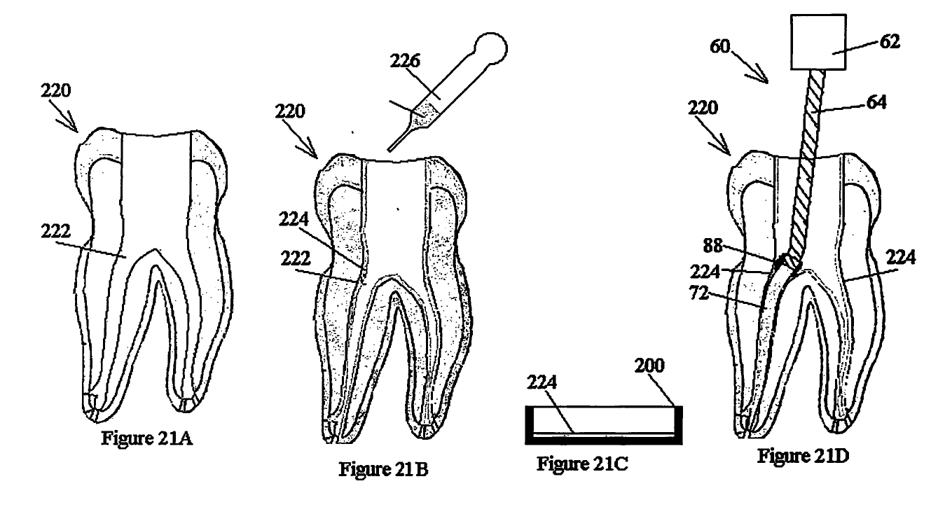

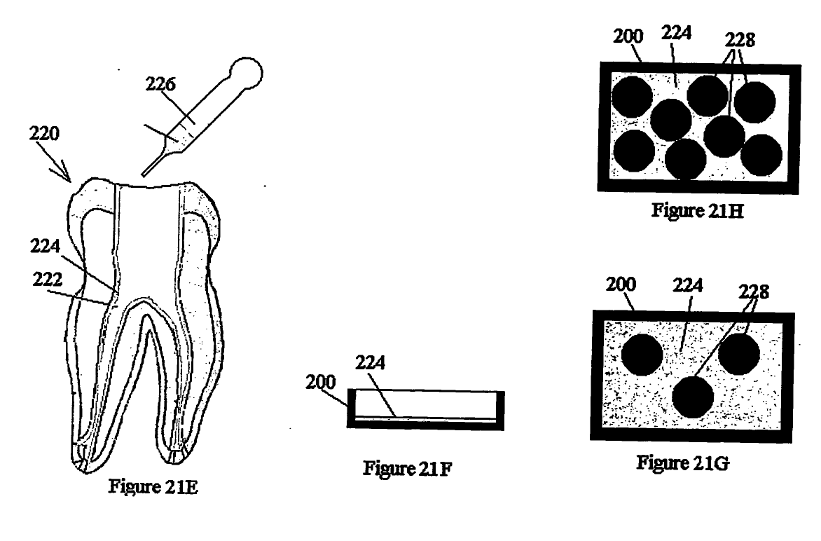

Referring further to the drawings, FIGS. 21A-21H schematically illustrate an intra-canal UV irradiation test, using a diffuser, in accordance with the present invention and in a manner similar to that taught, for example, by FIG. 7B, hereinabove.

As seen in FIG. 21A, root canals 222 of a dog tooth 220 were cleaned. Tooth 220 was then placed in an autoclave, for sterilization.

As seen in FIG. 21B, a medium 224 containing bacteria was introduced into root canals 222 of tooth 220 and allowed to incubate for a period of two days.

As seen in FIG. 21C, after incubation, a control sample of bacterial medium is 224 was taken from root canal 222, and placed in petri dish 200, to a single bacterial thickness, forming a control perti dish.

As seen in FIG. 21D, root canals 222 were irradiated via diffuser 72, coupled to light source 62 of a mercury-lamp ultraviolet light, as taught in conjunction with FIG. 7B, hereinabove. Based on the size of the gap between diffuser 72 and the walls of root canal 222, the number of bacterial layers could be estimated, since each bacterium is about 1 □^{□}□ Eighteen teeth were used, divided into groups of three or four teeth, and each group was irradiated to a different density. The irradiation density was measured at the walls of root canals 222. Average values for each group were taken.

As seen in FIGS. 21E -21F, after irradiation samples of bacterial medium 224 was taken from root canal 222, and placed in petri dishes 200, for incubation for 24 hours, as before.

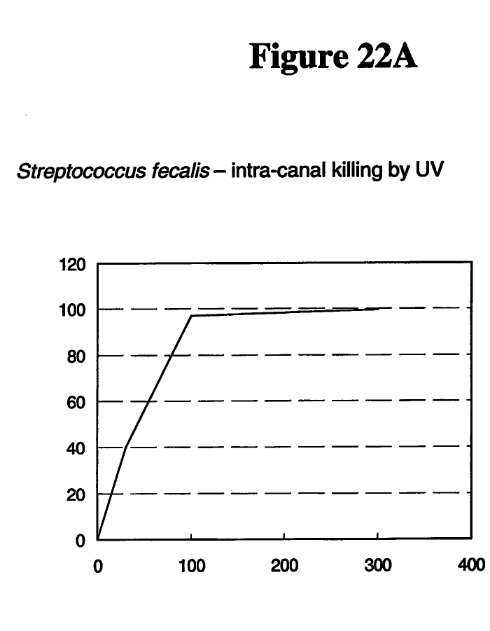

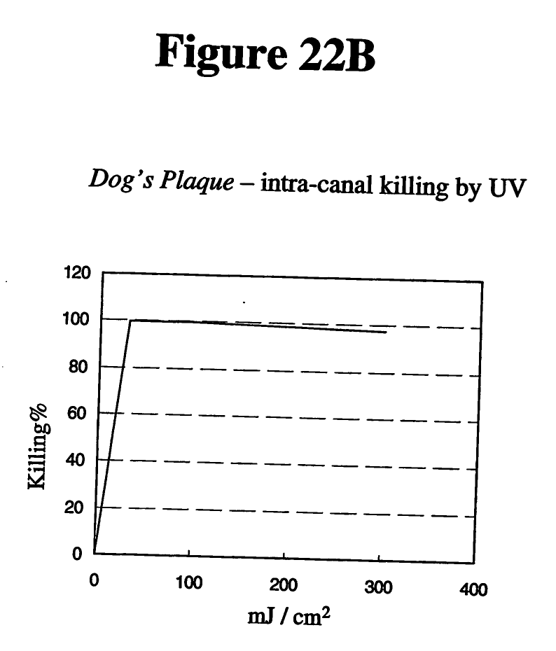

As seen in FIGS. 21G -21H, after the second incubation period, in petri dishes 200, the number of colonies in the irradiated dishes, for example, as in FIG. 221, were compared with those of the control dish of FIG. 22G.

Referring further to the drawings, FIGS. 22A-22B illustrate intra-canal UV irradiation tests for Streoptococcus Fecalis (FIG. 22A) and general dog tooth plaque (FIG. 22B).

As seen in FIG. 22A, for Streoptococcus Fecalis, about 98% killing was achieved with an irradiation density of 100 mJoule/cm² at the root canal walls, using a fused silica diffuser and UV light, produced by the mercury lamp.

As seen in FIG. 22B, for general dog tooth plaque, about 100% killing was achieved with an irradiation density of about 37 mJoule/cm² at the root canal walls, using a fused silica diffuser and UV light, produced by the mercury lamp.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

1. A method of root-canal photo-sterilizing, comprising:
forming an opening into the pulp chamber of a tooth;
removing the pulp from at least one infected root canal of said tooth;
cleaning the walls of said at least one root canal; and
photo-sterilizing said walls, by shining on them with light at a combination of wavelength and intensity operative to disinfect said walls.

2-26. (canceled)

27. A method of performing post-endodontic photo-sterilization of a root canal, comprising:
forming an opening into the pulp chamber of a tooth;
removing the pulp from at least one infected root canal of said tooth;
cleaning and shaping the walls of said at least one root canal;
filling said at least one root canal with a filling substance which comprises at least one light-transmitting element, in communication with said walls;
restoring said tooth; and
performing post-endodontic photo-sterilization of said root canal, by coupling a light source, at a combination of wavelength and intensity operative to disinfect said walls, with said at least one light-transmitting element.

28-56. (canceled)

57. A substance, operative as a light-transmitting sealer in a tooth filling, formed as a mixture, comprising:
an adhesive, selected from the group consisting of silicone polymers, silica, silicate, and a combination thereof; and
a filler, selected from the group consisting of fumed silica, quartz particles, barium sulfate, ring-opening polymers, and a combination thereof,
wherein said mixture comprises between 2% and 50% of said filler.

58. An endodontic diff-user, adapted in size and shape to be inserted into at least one root canal, for transmitting light by diffusion, for photo-sterilization of said root canal.

59. The endodontic diffuser of claim 58, formed of a material selected from the group consisting of silicone polymers, synthetic fused silica, quartz, poly-olefins, none-crystalline polyolefin, and a combination thereof.

60. The endodontic diffuser of claim 58, wherein said at least diffuser is formed of a light-transmitting shell and a fluid enclosed therein.

61. The endodontic diffuser of claim 60, wherein said light-transmitting shell is flexible.

62. The endodontic diffuser of claim 60, wherein said light-transmitting shell is formed of a polymer.

63. The endodontic diffuser of claim 60, wherein said light-transmitting shell is formed of Cyclic Olefin Copolymers (COC).

64. The endodontic diffuser of claim 60, wherein said light-transmitting shell is formed of COC 8007 Hi UV.

65. The endodontic diffuser of claim 60, wherein said light-transmitting shell is between 0.1 and 0.3 mm thick.

66. The endodontic diffuser of claim 60, wherein said fluid is selected from the group consisting of air, water and oil.

67. The endodontic diffuser of claim 60, wherein said shell is adapted to couple with an optical fiber by fitting around said optical fiber and gluing thereto.

68. The endodontic diffuser of claim 60, wherein said shell is adapted to couple with an optical fiber by tightly fitting around said optical fiber, for a quick connection.

69. The endodontic diffuser of claim 60, wherein a surface of said optical fiber, which forms contact with said fluid, is machined to form a lens, for improved light diffusion.

70. The endodontic diffuser of claim 60, wherein said diffuser is sealed with a plug, for insertion into a root canal, and further wherein said diffuser may be unplugged by inserting a hyperdemic needle through said plug, and pressurizing said diffuser, thus causing said plug to pop out, for performing said post-endodontic photo-sterilization of said root canal.

71. The endodontic diffuser of claim 58, having a length of between 8 and 25 mm in length.

72. The endodontic diffuser of claim 58, shaped generally as a cylindrical cone, and having a proximal diameter with respect to a crown of said tooth of between 0.5 and 2.0 mm.

73. The endodontic diffuser of claim 58, comprising two branches.

74. The endodontic diffuser of claim 58, comprising three branches.

75. The endodontic diffuser of claim 58, comprising four branches.

76. The endodontic diffuser of claim 58, formed as a plurality of optical fibers of different lengths, held together with a light transmitting sealant.

77. The endodontic diffuser of claim 58, comprising a plurality of surface pits whose diameters increase along the length of said diffuser, from between about 0.03 and about 0.05 mm in diameter, at a proximal end, with respect to the crown of said tooth, to between about 0.08 and about 0.15 mm in diameter, at a distal end, for providing a generally even light intensity on said walls.

78. The endodontic diffuser of claim 58, comprising a plurality of surface channels whose widths increase along the length of said diffuser, from between about 0.10 and about 0.15 mm, at a proximal end, with respect to the crown of said tooth, to between about 0.20 and about 0.30 mm, at a distal end, for providing a generally even light intensity on said walls.

79. The endodontic diffuser of claim 58, comprising a light coupler.

80. The endodontic diffuser of claim 58, comprising an optical-grade surface at a proximal end with respect the crown of said tooth.

81. The endodontic diffuser of claim 80, comprising a removable cap, for protecting said optical-grade surface.

82. A ring-shaped diffuser, adapted in size and shape to be inserted at an interface between a restored crown and a dentine tissue of a tooth, for transmitting light by diffusion, for photo-sterilization of said interface.

83. The ring-shaped diffuser of claim 82, formed of a material selected from the group consisting of silicone polymers, synthetic fused silica, quartz, poly-olefins, none-crystalline polyolefin, and a combination thereof.

84-142. (canceled)
